(19) United States
(12) Patent Application Publication
(10) Pub. No.: US 2026/0199980 A1
(43) Pub. Date: Jul. 16, 2026

(54) CONTROLLING ROBOTS FOR MANUFACTURING OBJECTS USING MAGNETIC PARTICLES

(71) Applicant: International Business Machines Corporation, Armonk, NY (US)

(72) Inventors: Sarbajit Kumar Rakshit, Kolkata (IN); Manikandan Padmanaban, Chennai (IN); Jagabondhu Hazra, Bangalore (IN)

(21) Appl. No.: 19/015,850

(22) Filed: Jan. 10, 2025

(51) Int. Cl. B22F 10/85; B22F 10/10; B22F 12/40; B22F 12/90; B33Y 10/00; B33Y 50/02

(52) U.S. Cl. CPC B22F 10/85; B22F 10/10; B22F 12/40; B22F 12/90; B22F 2202/05; B33Y 10/00; B33Y 50/02

(57) ABSTRACT

Controlling robots for manufacturing objects using magnetic particles includes obtaining of a first set of object parameters associated with at least a first shape of a first physical object. Based on the first set of object parameters, first control data is generated for each robot of a first set of robots. Based on the first control data, the first set of robots is controlled to generate a first physical arrangement of the first set of robots in a second shape similar to the first shape. A magnetic field of each robot of the first set of robots is adjusted to generate a first layer of magnetic particles on the first physical arrangement. A supply of a first amount of heat around at least one portion of the first layer of magnetic particles is controlled to generate a second physical object similar to the first physical object.

### BACKGROUND

The disclosure relates generally to the field of powder metal manufacturing, more particularly, to controlling robots for manufacturing objects using powder metal.

Powder metal manufacturing is a process that utilizes metal particles to generate physical objects. The metal particles are small fragments of metallic elements that exhibit chemical properties (such as oxide formation, corrosion, and the like) and physical properties (such as conductivity, malleability, density, and the like) of the corresponding metallic elements. Examples of metal particles include iron particles, aluminum particles, copper particles, nickel particles, stainless steel particles, cobalt particles, silver particles, gold particles, and titanium dioxide particles. The powder metal manufacturing includes compressing the metal particles into a desired shape using a die press. Further, the compressed metal particles are heated below a melting point of the metal particles, leading to a bonding between the metal particles in the desired shape. Moreover, the bonded metal particles in the desired shape are cooled to a desired temperature (such as 27 degrees Celsius), leading to the generation of the physical objects in the desired shape.

The utilization of the powder metal manufacturing for the generation of physical objects is advantageous as compared to traditional manufacturing techniques (such as a casting technique, a machining technique, and a forging technique) that typically generate the physical objects using molten metal or solid materials.

### SUMMARY

In various embodiments of the disclosure, a computer-implemented method for controlling robots for manufacturing objects using magnetic particles is provided. The computer-implemented method includes obtaining, by a computer, a first set of object parameters associated with at least a first shape of a first physical object. The computer-implemented method further includes generating, by the computer, first control data for each robot of a first set of robots based on the first set of object parameters. The computer-implemented method further includes controlling, by the computer, the first set of robots based on the first control data. The first set of robots is controlled to generate a first physical arrangement of the first set of robots in a second shape similar to the first shape. The computer-implemented method further includes adjusting, by the computer, a magnetic field of each robot of the first set of robots based on the first set of object parameters. The magnetic field is adjusted to generate a first layer of magnetic particles on the first physical arrangement of the first set of robots. The computer-implemented method further includes controlling, by the computer, a supply of a first amount of heat around at least one portion of the first layer of magnetic particles based on the adjustment and the first set of object parameters. The first amount of heat is controlled to generate a second physical object having a shape that is similar to the first shape of the first physical object.

In various embodiments of the disclosure, a computer system for controlling robots for manufacturing objects using magnetic particles is provided. The computer system includes a processor set, one or more computer-readable storage media, and program instructions stored on the one or more computer-readable storage media. The program instructions are executable by the processor set to cause the processor set to obtain a first set of object parameters associated with at least a first shape of a first physical object. The program instructions further cause the processor set to generate first control data for each robot of a first set of robots based on the first set of object parameters. The program instructions further cause the processor set to control the first set of robots based on the first control data. The first set of robots is controlled to generate a first physical arrangement of the first set of robots in a second shape similar to the first shape. The program instructions further cause the processor set to adjust a magnetic field of each robot of the first set of robots based on the first set of object parameters. The magnetic field is adjusted to generate a first layer of magnetic particles on the first physical arrangement of the first set of robots. The program instructions further cause the processor set to control a supply of a first amount of heat around at least one portion of the first layer of magnetic particles based on the adjustment and the first set of object parameters. The first amount of heat is controlled to generate a second physical object having a shape that is similar to the first shape of the first physical object.

In various embodiments of the disclosure, a computer program product for controlling robots for manufacturing objects using magnetic particles is provided. The computer program product includes one or more computer-readable storage media. The program instructions are stored on the one or more computer-readable storage media to perform operations. The operations include obtaining a first set of object parameters associated with at least a first shape of a first physical object. The operations include generating first control data for each robot of a first set of robots based on the first set of object parameters. The operations include controlling the first set of robots based on the first control data. The first set of robots is controlled to generate a first physical arrangement of the first set of robots in a second shape similar to the first shape. The operations include adjusting a magnetic field of each robot of the first set of robots based on the first set of object parameters. The magnetic field is adjusted to generate a first layer of magnetic particles on the first physical arrangement of the first set of robots. The operations include controlling a supply of a first amount of heat around at least one portion of the first layer of magnetic particles based on the adjustment and the first set of object parameters. The first amount of heat is controlled to generate a second physical object having a shape that is similar to the first shape of the first physical object.

Additional technical features and benefits are realized through the techniques of the disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The following description will provide details of preferred embodiments with reference to the following figures wherein:

FIG. 1 is a diagram that illustrates a computing environment for controlling robots for manufacturing objects using magnetic particles, in accordance with an embodiment of the disclosure;

FIG. 2 is a diagram that illustrates an environment for controlling robots for manufacturing objects using magnetic particles, in accordance with an embodiment of the disclosure;

FIG. 3 is a diagram that illustrates exemplary operations for controlling robots for manufacturing objects using magnetic particles, in accordance with an embodiment of the disclosure;

FIG. 4 is a diagram that illustrates an exemplary scenario for controlling robots for manufacturing objects using magnetic particles, in accordance with an embodiment of the disclosure;

FIG. 5 is a diagram that illustrates a first flowchart of a method for controlling robots for manufacturing objects using magnetic particles, in accordance with an embodiment of the disclosure;

FIG. 6A is a diagram that illustrates an exemplary first user interface for controlling robots for manufacturing objects using magnetic particles, in accordance with an embodiment of the disclosure;

FIG. 6B is a diagram that illustrates an exemplary second user interface for controlling robots for manufacturing objects using magnetic particles, in accordance with an embodiment of the disclosure;

FIG. 7 is a diagram that illustrates a second flowchart of a method for controlling robots for manufacturing objects using magnetic particles, in accordance with an embodiment of the disclosure; and

FIG. 8 is a diagram that illustrates a third flowchart of a method for controlling robots for manufacturing objects using magnetic particles, in accordance with an embodiment of the disclosure.

### DETAILED DESCRIPTION

Powder metal manufacturing is a process that utilizes metal particles to generate physical objects. The metal particles are small fragments of metallic elements that exhibit chemical properties (such as oxide formation, corrosion, and the like) and physical properties (such as conductivity, malleability, density, and the like) of the corresponding metallic elements. Examples of the metal particles include iron particles, aluminum particles, copper particles, nickel particles, stainless steel particles, cobalt particles, silver particles, gold particles, and titanium dioxide particles. The powder metal manufacturing includes compressing the metal particles into a desired shape using a die press. Further, the compressed metal particles are heated below a melting point of the metal particles, leading to a bonding between the metal particles in the desired shape. Moreover, the bonded metal particles in the desired shape are cooled to a desired temperature (such as 27 degrees Celsius), leading to the generation of the physical objects in the desired shape.

The utilization of the powder metal manufacturing for the generation of the physical objects is advantageous as compared to traditional manufacturing techniques (such as casting, machining, and forging) that typically generate objects using molten metal or solid materials. The advantages include, but are not limited to, reduced manufacturing cost associated with the generation of the physical object, reduced material wastage of manufacturing materials, decreased manufacturing time for the generation of the physical object or enhanced physical properties of the formed physical objects.

In an example, the casting technique can be utilized for the generation of the physical object that includes melting the solid materials and pouring the melted solid materials into molds to generate the physical objects in the desired shape. However, in the casting technique, a manufacturing cost associated with the generation of the physical object increases with an increase in a complexity associated with a structure of the physical objects. Specifically, the manufacturing cost associated with the generation of the physical objects increases due to a need for complex designs of the molds in the casting technique. In this regard, in the powder metal manufacturing, the physical objects can be formed by compressing the metal particles into molds of simpler designs as compared to the complex designs of mold utilized in the casting technique, thereby reducing the manufacturing cost associated with the generation of the physical objects.

In an additional example, the machining technique or the forging technique can be utilized for the generation of the physical objects that includes a removal of the solid materials from the solid metals to generate the physical objects. However, the removal of the solid materials leads to a generation of material waste and further requires extensive tooling and setup time. In this regard, the utilization of the powder metal manufacturing is particularly advantageous due to a nearly complete utilization of the metal particles, thereby minimizing the generation of the material waste. The minimization of the material waste further decreases the manufacturing cost associated with the generation of the physical objects and promotes an adoption of the powder metal manufacturing.

Moreover, in the powder metal manufacturing, the metal particles can be blended with various alloys and additives to achieve enhanced metal properties, thereby enhancing strength of the formed physical objects. For example, composite powders (such as metal-metal composites, metal-ceramic composites, or metal-polymer composites) can be blended with the metal particles, leading to the generation of the physical objects with increased thermal stability, decreased degradation, and the like. Additionally, the powder metal manufacturing is closely allied with computer-aided manufacturing (such as computer-vision, robotic manipulation, and the like). The physical objects can be created with computer-aided manufacturing to simultaneously optimize a weight of the physical objects, a strength of the physical objects, a stiffness of the physical objects, and a hardness of the physical objects. This simultaneous optimization may be required for applications in various industries (such as an aerospace industry, an automobile industry, and the like). For example, the weight of the physical objects is minimized to minimize the consumption of fuel in automobiles.

However, there are challenges associated with the utilization of the powder metal manufacturing for the generation of the physical objects. For example, an incorrect distribution of the metal particles around the desired shape leads to a decrease in the physical properties (such as a mechanical strength) of the formed physical objects. In an additional example, an increase in a size of the desired shape of the physical objects leads to challenges associated with a designing of a dice press to store the metal particles. The challenges associated with the designing of the dice press include, but are not limited to, increased manufacturing costs associated with the designing of the dice press or increased manufacturing time for the generation of the physical objects. Additionally, an increase in the complexity associated with the physical objects further increases the challenges associated with the design of the dice press. Therefore, conventional powder metal manufacturing is generally applicable for smaller dimensions of the physical objects, if the physical object with larger dimensions is to be manufactured with power metal manufacturing, then there is a need for an appropriate large dice to hold the metal particles.

Additionally, an inability to maintain a desired temperature (say 27 degrees Celsius) for the heating and cooling of the metal particles leads to a change in the physical properties (such as the mechanical strength, the size, and the like) of the physical objects. Specifically, the heating of the metal particles at a temperature (say 29 degrees Celsius), that is greater than the desired temperature, leads to a generation of the formed physical objects in a shape different than the desired shape. In an additional example, the heating of the metal particles at a temperature (say 25 degrees Celsius), that is less than the desired temperature, leads to an incomplete bonding of the metal particles. The incomplete bonding of the metal particles further leads to the change in the physical properties of the physical objects. Specifically, the mechanical strength of the formed physical object decreases due to the incomplete bonding of the metal particles.

Hence, to mitigate the aforementioned challenges associated with the utilization of the powder metal manufacturing for the generation of the physical objects, there is a need for a system that can control a first plurality of robots to generate the desired shape of the physical objects automatically without any human intervention. The controlling of the first plurality of robots for the generation of the desired shape mitigates challenges associated with the designing of the dice. In an embodiment of the disclosure, the system utilizes object parameters (such as dimensions of the physical objects, density of the physical objects, and the like) to control the first plurality of the robots. The utilization of the object parameters for the controlling of the first plurality of robots ensures an accurate generation of the desired shape of the physical objects. Additionally, the system can utilize the object parameters to adjust the magnetic field of each robot of the first plurality of robots, thereby ensuring a correct distribution of magnetic particles around the formed desired shape of the physical objects.

The magnetic particles are small fragments of magnetic elements that exhibit chemical properties (such as oxide formation, corrosion, and the like) and physical properties (such as conductivity, malleability, density, and the like) of the corresponding magnetic elements. Examples of magnetic particles include iron particles, copper particles, and nickel particles. The utilization of the object parameters for the adjustment of the magnetic field mitigates challenges associated with the incorrect distribution of the magnetic particles. Specifically, the magnetic field of the fist plurality of robots is adjusted based on the object parameters (such as the density of the physical objects). Thereafter, the magnetic particles are attracted to the plurality of robots based on the adjustment of the magnetic field of the first plurality of robots, leading to the correct distribution of the magnetic particles on the first plurality of robots. In various embodiments of the disclosure, the system can control an amount of heat around the distributed magnetic particles to generate the physical objects in the desired shape. Additionally, the system can utilize the object parameters to control the amount of heat around the distributed magnetic particles. The utilization of the object parameters for controlling the amount the heat around the distributed magnetic particles mitigates challenges associated with the challenges in the maintenance of the desired temperature for the heating and the cooling of the magnetic materials. Additionally, the utilization of the system automates the generation of the physical objects, thereby minimizing manual efforts (such as handling material particles, and generation of the die press) associated with the generation of the physical objects. Moreover, the utilization of the system for the generation of the physical objects further decreases the time associated with the manufacturing of the physical objects. Further, the utilization of the system for the generation of the physical objects is cost-effective as compared to the traditional manufacturing techniques (such as casting, machining, and forging) that include manual efforts. Specifically, controlling the first plurality of robots to generate a physical arrangement of the first plurality of robots similar to the desired shape overcomes the need for the designing of the die press, leading to a decrease in the manufacturing cost associated with the generation of the physical objects.

In various embodiments of the disclosure, a computer-implemented method for controlling robots for manufacturing objects using magnetic particles is provided. The computer-implemented method includes obtaining, by the computer, a first set of object parameters associated with at least the first shape of a first physical object. The computer-implemented method further includes generating, by the computer, first control data for each robot of a first set of robots based on the first set of object parameters. The computer-implemented method further includes controlling, by the computer, the first set of robots based on the first control data. The first set of robots is controlled to generate a first physical arrangement of the first set of robots in a second shape similar to the first shape. The computer-implemented method further includes adjusting, by the computer, the magnetic field of each robot of the first set of robots based on the first set of object parameters. The magnetic field is adjusted to generate a first layer of magnetic particles on the first physical arrangement of the first set of robots. The computer-implemented method further includes controlling, by the computer, a supply of a first amount of heat around at least one portion of the first layer of magnetic particles based on the adjustment and the first set of object parameters. The first amount of heat is controlled to generate a second physical object having a shape that is similar to the first shape of the first physical object.

In various embodiments of the disclosure, the computer-implemented method further includes generating, by the computer, second control data for each robot of a second set of robots based on the first set of object parameters. The computer-implemented method further includes controlling, by the computer, the second set of robots based on the second control data to generate a second physical arrangement of the second set of robots. The second physical arrangement corresponds to at least one physical boundary around the at least one portion of the first layer of magnetic particles. The computer-implemented method further includes controlling, by the computer, the supply of the first amount of heat within the at least one physical boundary around the at least one portion of the first layer of magnetic particles based on the adjustment of the magnetic field and the first set of object parameters.

In various embodiments of the disclosure, the first control data includes a count of the first set of robots, a type of each robot of the first set of robots, a first set of control signals associated with a position of each robot of the first set of robots within an operational environment and a first set of timestamps associated with the position of each robot of the first set of robots within the operational environment.

In various embodiments of the disclosure, the computer-implemented method further includes generating, by the computer, third control data for each robot of a third set of robots based on the generation of the second physical object and the first set of object parameters. The computer-implemented method further includes controlling, by the computer, the third set of robots based on the third control data. The third set of robots is controlled to transfer the second physical object from a first location within the operational environment to a second location within a storage environment.

In various embodiments of the disclosure, the computer-implemented method further includes controlling, by the computer, an intensity of a laser beam around the at least one portion of the first layer of magnetic particles based on the adjustment of the magnetic field and the first set of object parameters. The intensity of the laser beam is controlled to generate the second physical object.

In various embodiments of the disclosure, the computer-implemented method further includes determining, by the computer, a set of magnetic field parameters based on the first set of object parameters. The set of magnetic field parameters is associated with the magnetic field of each robot of the first set of robots. The computer-implemented method further includes adjusting, by the computer, the magnetic field of each robot of the first set of robots based on the set of magnetic field parameters.

In various embodiments of the disclosure, the set of magnetic field parameters is associated with a magnetic strength associated with the magnetic field of each robot of the first set of robots and an orientation of the magnetic field of each robot of the first set of robots.

In various embodiments of the disclosure, the computer-implemented method further includes determining, by the computer, magnetic particle data based on the first set of object parameters. The magnetic particle data comprises at least an amount of magnetic particles in the first layer of magnetic particles. The computer-implemented method further includes adjusting, by the computer, the magnetic field of each robot of the first set of robots based on the magnetic particle data and the set of magnetic field parameters. The magnetic field of each robot of the first set of robots is adjusted to generate the first layer of magnetic particles on the first physical arrangement of the first set of robots.

In various embodiments of the disclosure, the computer-implemented method further includes controlling, by the computer, a first supply of the magnetic particles on the first physical arrangement of the first set of robots based on the magnetic particle data and the first set of object parameters. The computer-implemented method further includes adjusting, by the computer, the magnetic field of each robot of the first set of robots based on the control of the first supply of the magnetic particles and the first set of object parameters. The magnetic field of each robot of the first set of robots is adjusted to generate the first layer of the magnetic particles on the first physical arrangement of the first set of robots.

In various embodiments of the disclosure, the first set of object parameters is associated with a first set of dimensions of the first physical object or a first density of the first physical object.

In various embodiments of the disclosure, the computer-implemented method further includes determining, by the computer, a second set of object parameters based on the generation of the second physical object. The second set of object parameters is associated with at least a second set of dimensions of the second physical object. The computer-implemented method further includes determining, by the computer, a difference value between a dimension value associated with a dimension of the first set of dimensions and a dimension value associated with a dimension of the second set of dimensions. The computer-implemented method further includes comparing, by the computer, the difference value with a dimension threshold value. The computer-implemented method further includes controlling, by the computer, a second supply of the magnetic particles on the first physical arrangement of the first set of robots based on the comparison.

In various embodiments of the disclosure, the computer-implemented method further includes adjusting, by the computer, the magnetic field of each robot of the first set of robots based on the second supply of the magnetic particles on the first physical arrangements of the first set of robots and the first set of object parameters. The magnetic field is adjusted to generate a second layer of magnetic particles on the first physical arrangement of the first set of robots. The computer-implemented method further includes controlling, by the computer, a supply of a second amount of heat around at least one portion of the second layer of magnetic particles based on the adjustment of the magnetic field of each robot of the first set of robots. The second amount of heat is controlled to increase the dimension of the second set of dimensions of the second physical object.

In various embodiments of the disclosure, the computer-implemented method further includes outputting, by the computer, the first set of dimensions of the first physical object and the second set of dimensions of the second physical object on a user interface based on the generation of the second physical object.

In various embodiments of the disclosure, a computer system for controlling robots for manufacturing objects using magnetic particles is provided. The computer system includes a processor set, one or more computer-readable storage media, and program instructions stored on the one or more computer-readable storage media. The program instructions are executable by the processor set to cause the processor set to obtain a first set of object parameters associated with at least a first shape of a first physical object. The program instructions further cause the processor set to generate first control data for each robot of a first set of robots based on the first set of object parameters. The program instructions further cause the processor set to control the first set of robots based on the first control data. The first set of robots is controlled to generate a first physical arrangement of the first set of robots in a second shape similar to the first shape. The program instructions further cause the processor set to adjust magnetic field of each robot of the first set of robots based on the first set of object parameters. The magnetic field is adjusted to generate a first layer of magnetic particles on the first physical arrangement of the first set of robots. The program instructions further cause the processor set to control a supply of a first amount of heat around at least one portion of the first layer of magnetic particles based on the adjustment and the first set of object parameters. The first amount of heat is controlled to generate a second physical object having a shape that is similar to the first shape of the first physical object.

In various embodiments of the disclosure, the program instructions further cause the processor set to generate second control data for each robot of a second set of robots based on the first set of object parameters. The program instructions further cause the processor set to control the second set of robots based on the second control data to generate a second physical arrangement of the second set of robots. The second physical arrangement corresponds to at least one physical boundary around the at least one portion of the first layer of magnetic particles. The program instructions further cause the processor set to control the supply of the first amount of heat within the at least one physical boundary around the at least one portion of the first layer of magnetic particles based on the adjustment of the magnetic field and the first set of object parameters.

In various embodiments of the disclosure, the first control data includes a count of the first set of robots, a type of each robot of the first set of robots, a first set of control signals associated with a position of each robot of the first set of robots within an operational environment and a first set of timestamps associated with the position of each robot of the first set of robots within the operational environment.

In various embodiments of the disclosure, the program instructions further cause the processor set to determine a set of magnetic field parameters based on the first set of object parameters. The set of magnetic field parameters is associated with the magnetic field of each robot of the first set of robots. The program instructions further cause the processor set to adjust the magnetic field of each robot of the first set of robots based on the set of magnetic field parameters.

In various embodiments of the disclosure, the set of magnetic field parameters is associated with a magnetic strength associated with the magnetic field of each robot of the first set of robots and an orientation of the magnetic field of each robot of the first set of robots.

In various embodiments of the disclosure, the program instructions further cause the processor set to determine magnetic particle data based on the first set of object parameters. The magnetic particle data includes at least an amount of the magnetic particles in the first layer of magnetic particles. The program instructions further cause the processor set to adjust the magnetic field of each robot of the first set of robots based on the magnetic particle data and the set of magnetic field parameters. The magnetic field of each robot of the first set of robots is adjusted to generate the first layer of magnetic particles on the first physical arrangement of the first set of robots.

In various embodiments of the disclosure, a computer program product for controlling robots for manufacturing objects using magnetic particles is provided. The computer program product includes one or more computer-readable storage media. The program instructions stored on the one or more computer-readable storage media to perform operations. The operations include obtaining a first set of object parameters associated with at least a first shape of a first physical object. The operations include generating first control data for each robot of a first set of robots based on the first set of object parameters. The operations include controlling the first set of robots based on the first control data. The first set of robots is controlled to generate a first physical arrangement of the first set of robots in a second shape similar to the first shape. The operations include adjusting a magnetic field of each robot of the first set of robots based on the first set of object parameters. The magnetic field is adjusted to generate a first layer of magnetic particles on the first physical arrangement of the first set of robots. The operations include controlling a supply of a first amount of heat around at least one portion of the first layer of magnetic particles based on the adjustment and the first set of object parameters. The first amount of heat is controlled to generate a second physical object having a shape that is similar to the first shape of the first physical object.

Various aspects of the disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated operation, concurrently, or in a manner at least partially overlapping in time.

A computer program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the disclosure, is not to be construed as storage in the generate of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

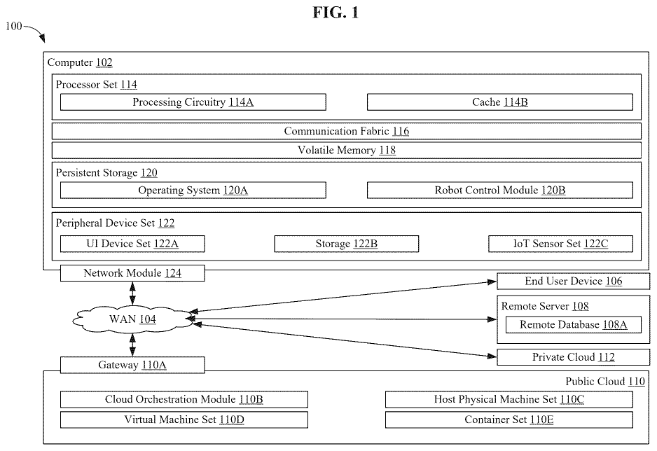

FIG. 1 is a diagram that illustrates a computing environment 100 for controlling robots for manufacturing objects using magnetic particles, in accordance with an embodiment of the disclosure. The diagram contains an exemplary environment for the execution of at least one module involved in performing the methods, such as a robot control module 120B associated with generating deployment data for machines based on simulations. In addition to the robot control module 120B, computing environment 100 includes, for example, a computer 102, a wide area network (WAN) 104, an end user device (EUD) 106, a remote server 108, a public cloud 110, and a private cloud 112. In this embodiment of the disclosure, the computer 102 includes a processor set 114 (including a processing circuitry 114A and a cache 114B), a communication fabric 116, a volatile memory 118, a persistent storage 120 (including an operating system 120A and the robot control module 120B, as identified above), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch or other wearable computer, a mainframe computer, a quantum computer, or any other form of a computer or a mobile device now known or to be developed in the future that is capable of running a program, accessing a network or querying a database, such as a remote database 108A. As is well understood in the art of computer technology, and depending upon the technology, the performance of a computer-implemented method may be distributed among multiple computers and/or between multiple locations. In an embodiment, in this presentation of the computing environment 100, detailed discussion is focused on a single computer, specifically the computer 102, to keep the presentation as simple as possible. The computer 102 may be located in a cloud, even though it is not shown in a cloud in FIG. 1. In an additional embodiment, computer 102 is not required to be in a cloud except to any extent as may be affirmatively indicated.

The processor set 114 includes one, or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B may be memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the methods”). These computer-readable program instructions are stored in various types of computer-readable storage media, such as the cache 114B and the other storage media discussed below. The program instructions, and associated data, are accessed by the processor set 114 to control and direct the performance of the methods. In computing environment 100, at least some of the instructions for performing the methods may be stored in the robot control module 120B in persistent storage 120.

The communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports, and the like. Various types of signal communication paths may be used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by random access, but this is not required unless affirmatively indicated. In the computer 102, the volatile memory 118 is located in a single package and is internal to computer 102, but alternatively or additionally, the volatile memory 118 may be distributed over multiple packages and/or located externally with respect to computer 102.

The persistent storage 120 is any form of non-volatile storage for computers that is now known or to be developed in the future. The non-volatility of this storage means that the stored data is maintained regardless of whether power is being supplied to computer 102 and/or directly to the persistent storage 120. The persistent storage 120 may be a read-only memory (ROM), but typically at least a portion of the persistent storage 120 allows the writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The robot control module 120B typically includes at least one module involved in performing the methods.

The peripheral device set 122 includes the set of peripheral devices of computer 102. Data communication connections between the peripheral devices and the other components of computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A may include components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B may be persistent and/or volatile. In some embodiments of the disclosure, storage 122B may take the form of a quantum computing storage device for storing data in the form of qubits. In embodiments of the disclosure where computer 102 is required to have a large amount of storage (for example, where computer 102 locally stores and manages a large database) then this storage may be provided by peripheral storage devices designed for storing very large amounts of data, such as a storage area network (SAN) that is shared by multiple, geographically distributed computers. The IoT sensor set 122C is made up of sensors that can be used in Internet of Things applications. For example, one sensor may be a thermometer, and another sensor may be a motion detector.

The network module 124 is the collection of computer software, hardware, and firmware that allows computer 102 to communicate with other computers through WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In various embodiments of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the methods can typically be downloaded to computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments of the disclosure, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is used and controlled by an end user (for example, a customer of an enterprise that operates computer 102) and may take any of the forms discussed above in connection with computer 102. The EUD 106 typically receives helpful and useful data from the operations of computer 102. For example, in a hypothetical case where computer 102 is designed to provide a recommendation to an end user, this recommendation would typically be communicated from the network module 124 of computer 102 through WAN 104 to EUD 106. In this way, the EUD 106 can display, or otherwise present recommendations to an end user. In some embodiments of the disclosure, EUD 106 may be a client device, such as a thin client, heavy client, mainframe computer, desktop computer, and so on.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data may be provided to the computer 102 from the remote database 108A of the remote server 108.

The public cloud 110 is any computer system available for use by multiple entities that provides on-demand availability of computer system resources and/or other computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments (VCEs) that run on various computers making up the computers of the host physical machine set 110C, which is the universe of physical computers in and/or available to the public cloud 110. The VCEs typically take the form of virtual machines from the virtual machine set 110D and/or containers from the container set 110E. It is understood that these VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows public cloud 110 to communicate through WAN 104.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to public cloud 110, except that the computing resources are only available for use by a single enterprise. While the private cloud 112 is depicted as being in communication with the WAN 104, in various embodiments of the disclosure, a private cloud may be disconnected from the internet entirely and only accessible through a local/private network. A hybrid cloud is a composition of multiple clouds of diverse types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment of the disclosure, the public cloud 110 and the private cloud 112 are both part of a larger hybrid cloud.

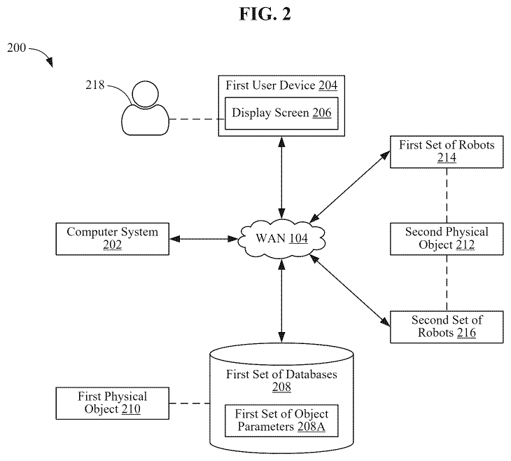

FIG. 2 is a diagram that illustrates an environment for controlling robots for manufacturing objects using magnetic particles, in accordance with an embodiment of the disclosure. FIG. 2 is explained in conjunction with elements from FIG. 1. With reference to FIG. 2, there is shown a diagram of a network environment 200. The network environment 200 includes a computer system 202, a first user device 204 that includes a display screen 206, a first set of databases 208 that is configured to store a first set of object parameters 208A associated with at least a first shape of a first physical object 210, a second physical object 212, a first set of robots 214, a second set of robots 216, and a user 218. The network environment 200 further includes the WAN 104 of FIG. 1. In an embodiment of the disclosure, the computer system 202 is an exemplary embodiment of the computer 102 in FIG. 1. Similarly, in an embodiment of the disclosure, the first user device 204 is an example embodiment of the EUD 106 of FIG. 1.

The computer system 202 includes suitable logic, circuitry, and/or interfaces for controlling robots for manufacturing objects using magnetic particles. The computer system 202 is configured to obtain the first set of object parameters 208A associated with the at least the first shape of the first physical object 210. The computer system 202 is further configured to generate first control data for each robot of the first set of robots 214 based on the first set of object parameters 208A. The computer system 202 is further configured to control the first set of robots 214 based on the first control data. The first set of robots 214 is controlled to generate a first physical arrangement of the first set of robots 214 in a second shape similar to the first shape. The computer system 202 is further configured to adjust a magnetic field of each robot of the first set of robots 214 based on the first set of object parameters 208A. The magnetic field is adjusted to generate a first layer of magnetic particles on the first physical arrangement of the first set of robots 214. The computer system 202 is further configured to control a supply of a first amount of heat around at least one portion of the first layer of magnetic particles based on the adjustment of the magnetic field and the first set of object parameters 208A. The first amount of heat is controlled to generate the second physical object 212 having a shape that is similar to the first shape of the first physical object 210.

Examples of the computer system 202 include but are not limited to, a server, a computing device, a virtual computing device, a mainframe machine, a computer workstation, a smartphone, a cellular phone, a mobile phone, a gaming device, or a consumer electronic (CE) device. In an example embodiment of the disclosure, the computer system 202 may be embodied as a cloud-based service, a cloud-based application, a cloud-based platform, a remote server-based service, a remote server-based application, a remote server-based platform, or a virtual computing system.

The first user device 204 may include suitable logic, circuitry, interfaces, and/or code that are configured to transmit the first set of object parameters 208A. The first user device 204 is further configured to transmit the first set of object parameters 208A to the computer system 202. In an embodiment, the first user device 204 may include the display screen 206. In an embodiment of the disclosure, the first user device 204 is further configured to display the first set of object parameters 208A on the display screen 206 associated with the first user device 204. The first user device 204 may be associated with the user 218. In an embodiment of the disclosure, the user 218 may be a person who wishes to generate the second physical object 212. In an embodiment of the disclosure, the user 218 may correspond to a stand-alone user (such as an operator of the first set of robots 214, the second set of robots 216, or a combination thereof). In various embodiments of the disclosure, the user 218 corresponds to a business entity that wants to manufacture spare parts for their products (such as vehicles, airplanes, electronic equipment, machines, and the like). Examples of the first user device 204 may include, but are not limited to, a computing device, a mainframe machine, a server, a computer work-station, a smartphone, a cellular phone, a mobile phone, a gaming device, a consumer electronic (CE) device, a head-mounted device, a Virtual Reality (VR) Headset, an Augmented Reality (AR) Device, a Mixed Reality (MR) Device, a Projection-based System, and/or any other device with computer vision display capabilities.

The display screen 206 may include suitable logic, circuitry, and interfaces that are configured to render the generated dimensions of the second physical object 212. In some embodiments of the disclosure, the display screen 206 may be an external display device associated with the first user device 204. The display screen 206 may be a touch screen which may enable the user 218 to provide the first set of object parameters 208A. The touch screen may be at least one of a resistive touch screen, a capacitive touch screen, or a thermal touch screen. In accordance with an embodiment of the disclosure, the display screen 206 may refer to a display screen 206 of a head-mounted device (HMD), a smart-glass device, a see-through display, a projection-based display, an electro-chromic display, or a transparent display. In some embodiments of the disclosure, the display screen 206 may be realized through several known technologies such as, but are not limited to, at least one of a Liquid Crystal Display (LCD) display, a Light Emitting Diode (LED) display, a plasma display, or an Organic LED (OLED) display technology, or other display devices.

Each of the first set of databases 208 may correspond to an organized collection of data that may be stored and accessed electronically from a computer system (such as the computer system 202). In an embodiment, the first set of databases 208 may store the first set of object parameters 208A associated with the at least the first shape of the first physical object 210. Each database of the first set of databases 208 may be designed to manage, store, retrieve, and update data efficiently. The structure of each database of the first set of databases 208 typically involves tables, records, and fields that can be managed through various database management systems (DBMS). Examples of each database of the first set of databases 208 may include, but are not limited to, a relational database, a Non-Structured Query Language (SQL) database, a hierarchical database, a network database, a transactional database, a data warehouse, and a distributed database.

The first physical object 210 is a tangible entity that exists in the real world and occupies space. Additionally, the first physical object 210 is associated with a set of properties (such as a size, a shape, a mass, and a texture). The first physical object 210 can be observed and interacted with through senses (such as sight, touch, hearing, and the like). Examples of the first physical object 210 include, but are not limited to, automative components (such as transmission gears, chain sprockets, piston rings, brake pads, rotors, camshafts, and the like), industrial components (such as lathes, drills, milling cutters, bushings, bearings, and the like), electronics components (such as transformers, inductors, magnetic shiels, electrical connectors, circuit breakers, switches relays, electrodes, and the like), aerospace components (such as brackets, support structures, panels, fuel nozzles, and the like), medical components (dental implants, hip joints, scissors, forceps, scalpels, and the like), and consumer goods (such as rings, bracelets, pendants, golf club heads, bicycle parts, tennis rackets, and the like.

Each robot of the first set of robots 214 includes suitable logic, circuitry, and/or interfaces that are configured to execute first one or more operations associated with the generation of the second physical object 212. The first one or more operations include, but are not limited to, generating the magnetic field to attract the magnetic particles, processing data (such as the first set of object parameters 208A, the first control data, and the like) associated with the generation of the second physical object 212, and transmitting the data associated with the generation of the second physical object 212. In an embodiment of the disclosure, each robot of the first set of robots 214 is configured to execute the first one or more operations based on programmable instructions, machine learning algorithms, or real-time decision-making capabilities. In various embodiments of the disclosure, each robot of the first set of robots 214 is configured to execute the first one or more operations based on the first control data generated by the computer system 202. In an embodiment of the disclosure, the first set of robots 214 is referred to a “first swarm robotic system”.

Each robot of the first set of robots 214 is equipped with one or more sensors that are configured to obtain data associated with an operational environment of each robot of the first set of robots 214. In an embodiment of the disclosure, the operational environment of each robot of the first set of robots corresponds to a manufacturing platform for the generation of the second physical object 212. Examples of the one or more sensors include, but are not limited to, camera sensors, light detection and ranging (LiDAR) sensors, ultrasonic sensors, infrared sensors, and tactile sensors. Additionally, each robot of the first set of robots 214 includes one or more processing components (such as a central processing unit, a microcontroller, and the like) that are configured to process the first control data and the data associated with the operational environment of each robot of the first set of robots 214. In an example, a first processing component of the one or more processing components is configured to process the first control data and data associated with an operational environment of the first robot of the first set of robots. Further, the first processing component is configured to control the first based on the processing of the first control data and the data associated with the operational environment of the first robot. Examples of the first set of robots 214 include, but are not limited to, articulated robots, collaborative robots, and automated guided vehicles.

Each robot of the second set of robots 216 includes suitable logic, circuitry, and/or interfaces that are configured to execute one or more operations associated with the generation of the at least one physical boundary around the at least one portion of the first layer of magnetic particles. The one or more operations include, but are not limited to, forming the at least one physical boundary around the at least one portion of the first layer of the magnetic particles, processing data associated with the generation of the at least one physical boundary around the at least one portion of the first layer of the magnetic particles, and transmitting the at least one physical boundary around the at least one portion of the first layer of the magnetic particles. In an embodiment of the disclosure, each robot of the second set of robots 216 is configured to execute the one or more operations based on the programmable instructions, the machine learning algorithms, or the real-time decision-making capabilities. In various embodiments of the disclosure, each robot of the second set of robots 216 is configured to execute the one or more operations based on the second control data generated by the computer system 202.

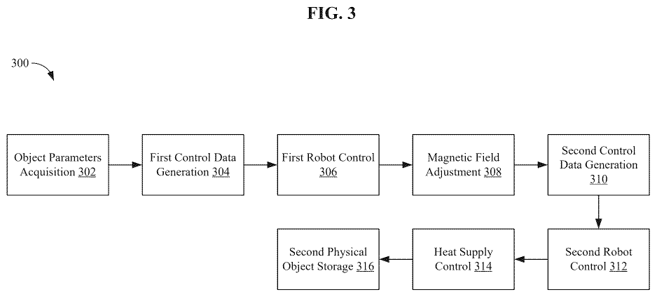

Each robot of the second set of robots 216 is equipped with one or more sensors that are configured to obtain data associated with the operational environment of each robot of the second set of robots 216. In an embodiment of the disclosure, the operational environment of each robot of the second set of robots 216 corresponds to the manufacturing platform for the generation of the second physical object 212. Examples of the one or more sensors include, but are not limited to, the cameras, the LiDAR sensors, the ultrasonic sensors, the infrared sensors, and the tactile sensors. Additionally, each robot of the second set of robots 216 includes one or more processing components (such as a central processing unit, a microcontroller, and the like) that are configured to process the second control data and the data associated with the operational environment of each robot of the second set of robots 216. In an example, a second processing component of the one or more processing components is configured to process the second control data and data associated with the operational environment of a first robot of the second set of robots 216. Further, the second processing component is configured to control the first robot of the second set of robots 216 based on the processing of the second control data and the data associated with the operational environment of the first robot of the second set of robots 216. Details about the controlling of the second set of robots 216 are provided, for example, in FIG. 3. In an embodiment of the disclosure, the second set of robots 214 is referred as “second swarm robotic system”.

In operation, the computer system 202 is configured to obtain the first set of object parameters 208A associated with at least the first shape of the first physical object 210. In an embodiment of the disclosure, the computer system 202 is configured to obtain the first set of object parameters 208A from the first set of databases 208.

The computer system 202 is further configured to generate the first control data for each robot of the first set of robots 214 based on the first set of object parameters 208A. The first control data includes a count of the first set of robots 214, a type of each robot of the first set of robots 214, a first set of control signals associated with a position of each robot of the first set of robots 214 within the operational environment and a first set of timestamps associated with the position of each robot of the first set of robots 214 within the operational environment. Details about the first control data are provided, for example, in FIG. 3.

The computer system 202 is further configured to control the first set of robots 214 based on the first control data. The first set of robots 214 is controlled to generate a first physical arrangement of the first set of robots 214 in a second shape similar to the first shape. Details about the controlling of the first set of robots 214 are provided, for example, in FIG. 3.

The computer system 202 is further configured to adjust the magnetic field of each robot of the first set of robots 214 based on the first set of object parameters 208A. The magnetic field is adjusted to generate a first layer of magnetic particles on the first physical arrangement of the first set of robots 214. Details about the adjustment of the magnetic field of the first set of robots 214 are provided, for example, in FIG. 3.

The computer system 202 is further configured to control a supply of a first amount of heat around at least one portion of the first layer of magnetic particles based on the adjustment and the first set of object parameters 208A. The supply of the first amount of heat is controlled to generate the second physical object 212 having a shape that is similar to the first shape of the first physical object 210. In an embodiment of the disclosure, the computer system 202 is further configured to control an intensity of a laser beam around the at least one portion of the first layer of magnetic particles based on the adjustment of the magnetic field and the first set of object parameters 208A. The intensity of the laser beam is controlled to generate the second physical object 212. Details about the controlling of the first amount of heat around the at least one portion of the first layer of magnetic particles are provided, for example, in FIG. 3.

The controlling of the first set of robots 214 for the generation of the second shape mitigates challenges associated with the design of the dice. In an embodiment of the disclosure, the computer system 202 utilizes the first set of object parameters 208A to control the first set of robots 214. Additionally, the computer system 202 can utilize the first set of object parameters 208A (such as a density of the first physical object 210) to adjust the magnetic field of each robot of the first set of robots 214, thereby ensuring a correct distribution of magnetic particles around the formed second shape. Further, the correct distribution of the magnetic particles around the formed second shape ensures an accurate generation of the second physical object 212 in the second shape similar to the first shape. The utilization of the first set of object parameters 208A for the adjustment of the magnetic field mitigates challenges associated with the incorrect distribution of the magnetic particles. Additionally, the computer system 202 utilizes the first set of object parameters 208A to control the supply of the amount of heat around the at least one portion of the first layer of magnetic particles based on the adjustment of the magnetic field and the first set of object parameters 208A. The utilization of the first set of object parameters 208A for the controlling of the first amount the heat mitigates one or more challenges associated with the incomplete bonding of the magnetic particles and dimensional changes of the generated second physical object 212.

In an alternate embodiment of the disclosure, there is a requirement to create a physical boundary around the at least one portion of the first layer of magnetic particles allows for holding of the magnetic particles on the first physical arrangement of the first set of robots 214. Additionally, the physical boundary around the at least one portion of the first layer of magnetic particles further allows for an accumulation of additional magnetic particles to increase a dimension of at least one of the first set of dimensions. To create the physical boundary, the computer system 202 is configured to generate second control data for each robot of the second set of robots 216 based on the first set of object parameters 208A. The second control data includes a count of the second set of robots 216, a type of each robot of the second set of robots 216, a second set of control signals associated with the position of each robot of the second set of robots 216 within the operational environment and a second set of timestamps associated with the position of each robot of the second set of robots 216 within the operational environment. Details about the second control data are provided, for example, in FIG. 3.

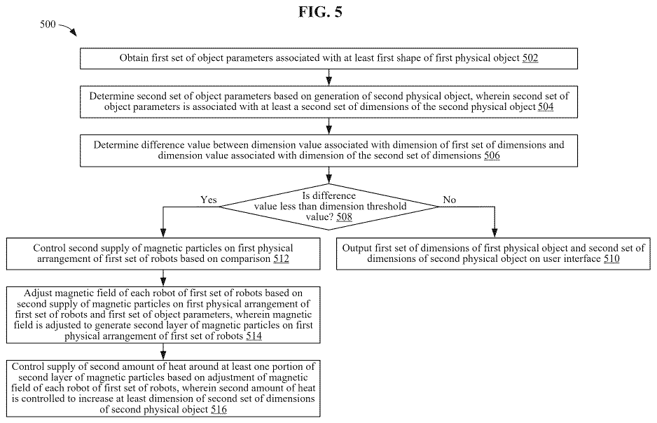

The computer system 202 is further configured to control the second set of robots 216 based on the second control data. The second set of robots 216 is controlled to generate a second physical arrangement of the second set of robots 216. The second physical arrangement of the second set of robots 216 corresponds to at least one physical boundary around the at least one portion of the first layer of magnetic particles. Accordingly, a flowchart is provided with reference to FIG. 5.

The computer system 202 is further configured to control the supply of the first amount of heat within the at least one physical boundary around the at least one portion of the first layer of magnetic particles. The supply of the first amount of heat is controlled based on the adjustment of the magnetic field and the first set of object parameters 208A. Details about the supply of the first amount of heat are provided, for example, in FIG. 3.

FIG. 3 is a diagram that illustrates exemplary operations for controlling robots for manufacturing objects using magnetic particles, in accordance with an embodiment of the disclosure. FIG. 3 is explained in conjunction with elements from FIG. 1, and FIG. 2. With reference to FIG. 3, there is shown a block diagram 300 that illustrates exemplary operations from 302 to 318, as described herein. The exemplary operations illustrated in the block diagram 300 may start at 302 and may be performed by any computing system, apparatus, or device, such as by the computer 102 of FIG. 1 or the computer system 202 of FIG. 2. Although illustrated with discrete blocks, the exemplary operations associated with one or more blocks of the block diagram 300 may be divided into additional blocks, combined into fewer blocks, or eliminated, depending on the particular implementation.

At 302, an object parameters acquisition operation may be executed. In the object parameters acquisition operation, the computer system 202 is configured to obtain the first set of object parameters 208A. The first set of object parameters 208A is associated with the first shape of the first physical object 210. In an embodiment of the disclosure, the computer system 202 is configured to obtain the first set of object parameters 208A from the first set of databases 208. In various embodiments of the disclosure, the computer system 202 is configured to obtain the first set of object parameters 208A from a user input from the user 218 associated with the first user device 204. In various embodiments of the disclosure, the computer system 202 is configured to obtain the first set of object parameters 208A from the one or more sensors (such as the camera sensors) associated with the first set of robots 214. In various embodiments of the disclosure, the computer system 202 is configured to obtain the first set of object parameters 208A from one or more sources (such as websites, technical specifications, industry standards protocols, and the like) associated with the first physical object 210.

In an embodiment of the disclosure, the first set of object parameters 208A is associated with a first set of dimensions of the first physical object 210 or a first density of the first physical object 210. Specifically, the first set of dimensions of the first physical object 210 is associated with the first shape of the first physical object 210. The first shape of the first physical object 210 corresponds to an external form of the first physical object 210. In an embodiment of the disclosure, the external form is defined based on one or more outlines of the first physical object 210. The first set of dimensions includes a length of the first physical object 210, a breadth of the first physical object 210, and a height of the first physical object 210. In an embodiment of the disclosure, the length of the first physical object 210 corresponds to a first dimension that is indicative of a first maximum horizontal distance from one end of the first physical object 210 to an opposite end along a principal axis of the first physical object 210. In an embodiment of the disclosure, the breadth of the first physical object 210 corresponds to a second dimension perpendicular to the first dimension of the first physical object 210. Further, the breadth of the first physical object 210 is indicative of a second maximum distance from one side of the first physical object 210 to an opposite side of the first physical object 210. In an embodiment of the disclosure, the height of the first physical object 210 corresponds to a third dimension that is indicative of a vertical maximum distance from a base point of the first physical object 210 to a top point of the first physical object 210. In an embodiment of the disclosure, the first set of dimensions is measured in meters (m). For example, the length of the first physical object 210, the breadth of the first physical object 210, and the height of the first physical object 210 are 6 m, 5 m and 2 m, respectively. The first density of the first physical object 210 corresponds to a mass per unit volume of the first physical object 210. Mathematically, the first density of the first physical object 210 is represented by equation (1) as follows:

$$ρ = \frac{m}{V} \qquad ( 1 )$$

Where, m is a mass of the first physical object 210,
ρ is the density of the first physical object 210, and
V is a volume of the first physical object 210.

The mass of the first physical object 210 corresponds to an amount of matter in the first physical object 210 and is measured in grams (g). The density of the first physical object 210 corresponds to an amount of space the first physical object 210 occupies within the operational environment and is measured in cubic meters (m³). The density of the first physical object 210 is measured in units (such as grams per cubic meter (g/m³)). In an example, the mass of the first physical object 210 is 121 g and the density of the first physical object 210 is 11 m³, thereby the first density of the first physical object 210 is 11 g/m³.

In an alternate embodiment of the disclosure, the first set of object parameters 208A is associated with a second set of dimensions of one or more portions of the first physical object 210. The second set of dimensions is associated with a first set of lengths of the one or more portions of the first physical object 210, a first set of breadths of the one or more portions of the first physical object 210, a first set of heights of the one or more portions of the first object, and a first set of densities associated with the one or more portions of the first physical object 210. The utilization of the second set of dimensions of the one or more portions of the first physical object 210 allows for a generation of objects with irregular sides.

In an embodiment of the disclosure, the computer system 202 is configured to determine the second shape based on the first set of object parameters 208A. In an embodiment of the disclosure, the computer system 202 is configured to determine the second shape identical to the first shape based on the first set of object parameters 208A. Specifically, the computer system 202 is configured to determine the second shape identical to the first shape based on an identical parameter value of each parameter of the first set of object parameters 208A. In various embodiments of the disclosure, the computer system 202 is configured to update at least one parameter value associated with the first set of object parameters 208A based on a first user input. The updating of the at least one parameter value allows for the generation of the second physical object 212 with updated at least one parameter value. Specifically, the updating of the at least parameter value allows for the generation of the second physical object 212 having the shape that is similar to the first shape of the first physical object. In an example, the updating of the at least one parameter value allows for the generation of the second physical object 212 with a variation in dimensions from the dimensions of the first physical object 210 (say a first length of the second physical object 212 greater than the length of the first physical object 210). In an additional example, the updating of the at least one parameter value allows for the generation of the second physical object 212 with a second length less than the length of the first physical object 210. The first user input is associated with the user 218. The first user input is indicative of an update in the at least one parameter value. In an embodiment of the disclosure, the computer system 202 is configured to increase the at least one parameter value based on the first user input. In an example, a first parameter value associated with the length of the first physical object 210 is 7 m and the first user input is indicative of an increase of 2 m in the first parameter value. Further, the computer system 202 is configured to update the first parameter value to 9 m. In an alternate embodiment of the disclosure, the computer system 202 is configured to decrease the at least one parameter value based on the first user input. In an additional example, a second parameter value associated with the length of the first object is 10 m and the first user input is indicative of a decrease of 2 m in the second parameter value. Further, the computer system 202 is configured to update the second parameter value to 8 m. Additionally, the computer system 202 is configured to determine the second shape similar to the first shape based on the updating of each parameter value associated with the first set of dimensions.

In various embodiments of the disclosure, the computer system 202 is configured to update at least one parameter value associated with the first set of object parameters 208A based on a predefined parameter value. In an embodiment of the disclosure, the predefined parameter value is associated with a change in a dimensional requirement for the generation of the second physical object 212. In an embodiment of the disclosure, the computer system 202 is configured to increase the at least one parameter value with the predefined parameter value. In an example, a first parameter value associated with the breadth of the first physical object 210 is 7 m and the predefined parameter value is 2 m. Further, the computer system 202 is configured to increase the first parameter value to 9 m based on the predefined parameter value. In various embodiments of the disclosure, the computer system 202 is configured to decrease the at least one parameter value with the predefined parameter value. In an additional example, a second parameter value associated with the breadth of the first physical object 210 is 9 m and the predefined parameter value is 2 m. Further, the computer system 202 is configured to decrease the first parameter value to 7 m based on the predefined parameter value.

At 304, a control data generation operation is executed. In the control data generation operation, the computer system 202 is configured to generate the first control data for each robot of the first set of robots 214. In an embodiment of the disclosure, the computer system 202 is configured to generate the first control data based on the first set of object parameters 208A. The first control data includes the count of the first set of robots 214, a type of each robot of the first set of robots 214, a first set of control signals associated with a position of each robot of the first set of robots 214 within the operational environment and a first set of timestamps associated with the position of each robot of the first set of robots 214 within the operational environment. In an embodiment of the disclosure, the computer system 202 is further configured to obtain a first set of robot parameters associated with each robot of the first set of robots 214. The first set of robot parameters is indicative of a first identifier associated with each robot of the first set of robots 214, the type of each robot of the first set of robots 214, or a combination thereof. In an example, the first identifier corresponds to a set of unique characters (such as 1, A, b, #, and the like). In an embodiment of the disclosure, the computer system 202 is configured to obtain the first set of robot parameters from one or more sources (such as websites, articles, and the like) associated with a manufacturer of the first set of robots 214. Further, the computer system 202 is further configured to generate the first control data based on the first set of object parameters 208A and the first set of robot parameters.

In an embodiment of the disclosure, the count of the first set of robots 214 is indicative of a total number of the first set of robots 214 that may be required for the generation of the first physical arrangement. In an example, the count of the first set of robots corresponds to a numerical value such as 1, 2, 4, 20, or 200. In an embodiment of the disclosure, a first type of a first robot of the first set of robots 214 is indicative of one or more classifications associated with the first robot of the first set of robots 214. Examples of the one or more classifications include, but are not limited to, an articulated robot type, an electromagnetic manipulator type, a collaborative type, a flat top surface type, and a magnetic field generator type. The articulated robot type indicates that the first robot includes rotatory joints with one or more robotic arms. The electromagnetic manipulator type indicates that the first robot includes electromagnetic manipulators that are configured to adjust a magnetic field of the first robot. The collaborative type indicates that the first robot is configured to couple with the at least one robot of the first set of robots 214. The first robot is configured to couple with the at least one robot of the first set of robots based on a mechanical coupling, electromagnetic coupling, and any combination thereof. Additionally, the first robot is configured to couple with the at least one robot on any side. The flat top surface type indicates that the first robot includes a flat top surface. Additionally, the flat top surface type indicates that the first robot is a square shaped robot that can perform self-mobility operations. The magnetic field generator type indicates that the first robot is configured to generate a magnetic field around the at least one portion of the first robot. Additionally, the magnetic field generator type indicates that the first robot includes magnetic field generation modules that are configured to generate the magnetic field around the first robot. The generation of the magnetic field around the at least one portion of the first robot leads to an accumulation of the magnetic particles on the at least one portion of the first robot.

In an embodiment of the disclosure, the first control data includes a set of coordinates to indicate the position of each robot of the first set of robots 214 within the operational environment. In an embodiment of the disclosure, the set of coordinates is indicative of the position of each robot of the first set of robots 214 from a center coordinate within the operational environment. The center coordinate is indicative of a center of the second shape. In an example, the center coordinate is (0,0,0) and a first coordinate of the set of coordinates is (1,5,7) that indicates a first position of the first robot from the center coordinate. In an embodiment of the disclosure, a first timestamp of the set of timestamps is indicative of the first position of the first robot within the operational environment at a first time instance (for example, 11:00:00 11 Nov., 2024).

In an embodiment of the disclosure, the first set of robot parameters is associated with a first set of robot dimensions. The first set of robot dimensions is associated with at least a length of each robot of the first set of robots 214, a breadth of each robot of the first set of robots 214, and a height of each robot of the first set of robots 214.

In an embodiment of the disclosure, the length of the first robot corresponds to a first dimension that is indicative of a first maximum horizontal distance from one end of the first robot to an opposite end along a principal axis of the first robot. In an embodiment of the disclosure, the breadth of the first robot corresponds to a second dimension perpendicular to the first dimension of the first robot. Further, the breadth of the first robot is indicative of a second maximum distance from one side of the first robot to an opposite side of the first robot. In an embodiment of the disclosure, the height of the first robot corresponds to a third dimension that is indicative of a vertical maximum distance from a base point of the first robot to a top point of the first robot. In an embodiment of the disclosure, the first set of robot dimensions is measured in meters (m). In an example, the length of the first robot, the breadth of the first robot, and the height of the first robot are 5.9 m, 7 m, and 1.5 m, respectively.

The computer system 202 is further configured to determine the count of each robot of the first set of robots 214 based on a mapping of the first set of robot dimensions with the first set of dimensions of the first physical object 210. Specifically, the computer system 202 is configured to determine a first number of robots for generating a length of the first shape of the first physical object 210. In an embodiment of the disclosure, the computer system 202 is configured to map the first length of the first physical object 210 with a first length of the first robot. The computer system 202 is further configured to determine a first difference between the first length of the first physical object 210 and the first length of the first robot. The computer system 202 is further configured to compare the first difference between the first length of the first physical object 210 and the first length of the first robot with a first length threshold. Further, the computer system 202 is configured to determine that the first number of robots for the generation of the second shape is 1 based on a determination that the first difference between the first length of the first physical object 210 and the first length of the first robot is less than or equal to the first length threshold.

By way of example, and not by limitation the length of the first physical object 210 is 6 m, the length of the first robot is 5.9 m, and the first length threshold is 0.2 m. Further, the computer system 202 is configured to determine that the first difference is 0.1 m between 6 m and 5.9 m. Thereafter, the computer system 202 is configured to determine that the first difference (0.1) is less than the first length threshold (0.2). To this end, the computer system 202 is configured to determine that the first number of robots for generating the second shape is 1 based on a determination that the first difference is less than the first length threshold.

In an embodiment of the disclosure, the computer system 202 is configured to map the first length of the first robot and a second length of a second robot with the first length of the first object based on a determination that the first difference between the first length of the first physical object 210 and the first length of the first robot is greater than the first length threshold. The second robot is associated with the first set of robots 214. Specifically, the computer system 202 is configured to determine a first sum of the first length of the first robot and the second length of the second robot. Further, the computer system 202 is configured to determine a second difference between the first sum of the first length of the first robot and the second length of the second robot with the first length of the first object.

Further, the computer system 202 is configured to determine that the first number of robots for generating the second shape is 2 based on a determination that the second difference between the first sum and the first length of the first object is less than or equal to the first length threshold. In an alternate embodiment of the disclosure, the computer system 202 is configured to map a sum of the first length of the first robot, the second length of the second robot, and a third length of a third robot with the length of the first robot until the determination of the first number of robots.

In an additional example, the length of the first physical object 210 is 6 m, the length of the first robot is 3 m, the length of the second robot is 3 m, and the first length threshold is 0.2 m. Further, the computer system 202 is configured to determine that the first difference is 3 m between the length (6 m) of the first object and the length of the first robot (3 m). Thereafter, the computer system 202 is configured to determine that the first difference (3 m) is greater than the first length threshold (0.2). Therefore, the computer system 202 is further configured to determine the first sum is 6 m of the length of the first robot (3 m) and the length of the second robot. Thereafter, the computer system 202 is configured to determine that the second difference is 0 m between the first sum (6 m) and the length (6 m) of the first physical object 210. The computer system 202 is configured to determine that the second difference (0 m) is less than the first length threshold (0.2 m). To this end, the computer system 202 is configured to determine that the first number of robots for generating the second shape is 2 based on a determination that the second difference is less than the first length threshold.

Similarly, the computer system 202 is configured to determine a second number of robots and a third number of robots used for the width of the first physical object 210 and the height of the first physical object 210, respectively. Thereafter, the computer system 202 is configured to determine the count of the first set of robots 214 based on a sum of at least the first number of robots, the second number of robots, and the third number of robots. In an embodiment of the disclosure, the computer system 202 is further configured to transmit the first control data to each robot of the first set of robots 214.

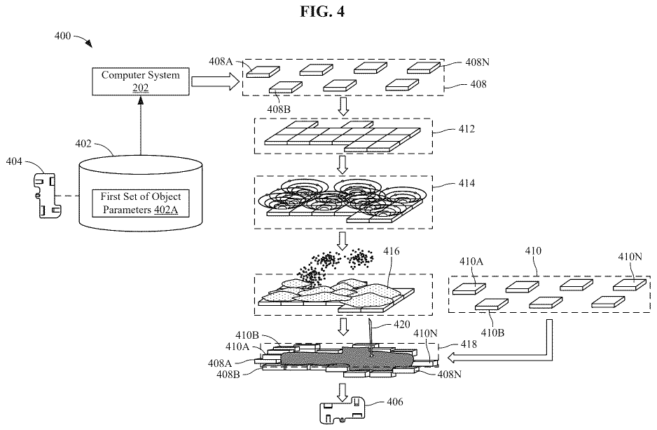

At 306, a first robot control operation is executed. In the first robot control operation, the computer system 202 is configured to control the first set of robots 214 based on the first control data. The first set of robots 214 is controlled to generate the first physical arrangement of the first set of robots 214 in the second shape similar to the first shape. Specifically, the computer system 202 is configured to control the first set of robots 214 to generate the first physical arrangement of the first set of robots 214 within the operational environment. In an embodiment of the disclosure, the computer system 202 is configured to control the first set of robots 214 to change a location of each robot of the first set of robots 214 within the operational environment. The location of each robot of the first set of robots 214 is changed to generate the first physical arrangement of the first set of robots 214 in the second shape similar to the first shape. The first physical arrangement includes one or more rows of robots that are arranged with respect to the length of the first physical object 210, the breadth of the first physical object 210, and the height of the first physical object 210, respectively. Accordingly, a diagram is provided for the first physical arrangement of the first set of robots 214 with reference to FIG. 4.

In an embodiment of the disclosure, the first control data includes a first set of coordinates to indicate the first position of the first robot within the first physical arrangement. In an embodiment of the disclosure, the first set of coordinates is denoted as (x, y, z), where x is a first coordinate that is indicative of a first position of the first robot with respect to the first one or more rows of robots, y is a second coordinate that is indicative of the first position of the first robot with respect to the second one or more rows of robots, and z is a third coordinate that is indicative of the first position of the first robot with respect to the first one or more columns of robots. In an example, the first set of coordinates (1,5,1) that is indicative of the first position of the first robot is at a first row (1) of the first one or more rows of robots, a fifth row of the second one or more rows of robots, and first column (1) of the first one or more columns of robots. In an embodiment of the disclosure, the computer system 202 is configured to transmit a first control signal of the first set of control signals to the first robot. Further, the computer system 202 is configured to control the first robot to change the location of the first robot based on the first set of coordinates. Similarly, the computer system 202 is configured to control each robot of the first set of robots 214 to generate the first physical arrangement of the first set of robots 214.

At 308, a magnetic field adjustment operation is executed. In the magnetic field adjustment operation, the computer system 202 is configured to adjust the magnetic field of each robot of the first set of robots 214 based on the first set of object parameters 208A. The magnetic field is adjusted to generate a first layer of magnetic particles on the first physical arrangement of the first set of robots 214. As discussed above, the computer system 202 is configured to generate the first physical arrangement of the first set of robots 214 based on the first control data. Further, the computer system 202 is configured to adjust the magnetic field of each robot of the first set of robots 214 after the generation of the first physical arrangement of the first set of robots 214. Specifically, the computer system 202 is configured to adjust the magnetic field of each robot associated with the generated first physical arrangement of the first set of robots 214 based on the first set of object parameters 208A. The magnetic field is adjusted to generate the first layer of magnetic particles on the generated first physical arrangement of the first set of robots 214.

In an embodiment of the disclosure, the computer system 202 is configured to determine a set of magnetic field parameters based on the first set of object parameters 208A. The set of magnetic field parameters is associated with the magnetic field of each robot of the first set of robots 214. In an embodiment of the disclosure, the set of magnetic field parameters is associated with a magnetic strength associated with the magnetic field of each robot of the first set of robots 214 or an orientation of the magnetic field of each robot of the first set of robots 214.

In an embodiment of the disclosure, a first magnetic field of the first robot corresponds to at least one portion of the operational environment in which a magnetic force generated by the first robot is detected. In an embodiment of the disclosure, a first magnetic strength associated with a fist magnetic field is indicative of a first intensity of the first magnetic field at a first coordinate within the operational environment. The first magnetic strength is measured in Tesla (T) or Gauss (G), where 1 Tesla=1000 Gauss. In an embodiment of the disclosure, a first orientation of the first magnetic field is indicative of a directional alignment of the magnetic field with respect to a reference frame. The reference frame is defined with respect to the first set of robot dimensions associated with the first robot. The first orientation of the first magnetic field is represented by a set of vectors that are indicative of a direction of field lines at the first coordinate within the operational environment.

The computer system 202 is further configured to adjust the magnetic field of each robot of the first set of robots 214 based on the set of magnetic field parameters. In an embodiment of the disclosure, each robot of the first set of robots includes electromagnetic coils that are configured to generate the magnetic field around the one or more portions associated with the first set of robots 214. In an embodiment of the disclosure, the computer system 202 is configured to determine the first magnetic strength of the first magnetic field based on the volume (V) of the first physical object 210, the first density (ρ) of the first physical object 210, and a gravitational acceleration (g). The gravitational acceleration is a rate at which a velocity of an object (such as the first physical object 210) changes due to a gravitational force exerted by a massive body (such as Earth). The gravitational acceleration is a nearly constant value that corresponds to 9.81 meters per second square (m/s²). Specifically, the computer system 202 is configured to determine a first magnetic force exerted by the first magnetic field on the magnetic particles based on the volume (V) of the first physical object 210, the first density (ρ) of the first physical object 210, and the gravitational acceleration (g). Mathematically, the first magnetic force is represented by equation (2) as follows:

$$F = V \times ρ \times g \qquad ( 2 )$$

In an alternate embodiment of the disclosure, the computer system 202 is configured to determine magnetic particle data based on the first set of object parameters 208A. The magnetic particle data includes at least an amount of the magnetic particles for generating the second physical object 212. The amount of the magnetic particles for generating the second physical object 212 is measured in grams (gm). For example, the amount of the magnetic particles for generating the second physical object 212 is 30 gm. In an embodiment of the disclosure, the computer system 202 is configured to determine the amount of the magnetic particles (denoted by α) based on the volume (V) of the first physical object 210 and the first density (ρ) of the first physical object 210. In an embodiment of the disclosure, the first density of the first physical object 210 is referred to as “accumulation density”. Mathematically, the amount of the magnetic particles for generating the second physical object 212 is represented by equation (3) as follows:

$$a = ρ \times V \qquad ( 3 )$$

In an embodiment of the disclosure, the computer system 202 is configured to determine the first magnetic force exerted by the first magnetic field on the magnetic particles based on the amount of the magnetic particles used for the generation of the second physical object 212 and the gravitational acceleration. Mathematically, the first magnetic force is represented by equation (4) as follows:

$$F = a \times g \qquad ( 4 )$$

Additionally, the magnetic particle data is indicative of a distance between the magnetic particles and each robot of the first set of robots 214, a material type associated with the magnetic particles, a magnetic permeability of the material type associated with the magnetic particles, and a magnetic moment of the material type associated with the magnetic particles. In an embodiment of the disclosure, the computer system 202 is configured to determine the distance between the magnetic particles and each robot of the first set of robots 214 using the first one or more sensors associated with the first set of robots 214. In an embodiment of the disclosure, the computer system 202 is configured to obtain the magnetic particle data from one or more sources associated with the magnetic particles. The one or more sources include, but are not limited to, a database associated with the magnetic particles, websites associated with the magnetic particles, and the like.

In an embodiment of the disclosure, the material type associated with the magnetic particle corresponds to iron, nickel, cobalt, and the like. In an embodiment of the disclosure, the magnetic permeability of the material type is indicative of an ability to support the generation of the magnetic field within the material type. The magnetic permeability is measured in Tesla per ampere-meter (T m/A). In an embodiment of the disclosure, the magnetic moment is indicative of an ability of the material type to produce the magnetic field. The magnetic field is measured in ampere-square meters (A m²).

In an embodiment of the disclosure, the computer system 202 is configured to determine the first magnetic strength (denoted by B) associated with the first magnetic field based on the first magnetic force (denoted by F) exerted by the first magnetic field on the magnetic particles, the distance between the magnetic particles and the first robot, the material type associated with the magnetic particles, the magnetic permeability (denoted by μ) of the material type associated with the magnetic particles, and the magnetic moment (denoted by m) of the material type associated with the magnetic particles. Mathematically, the first magnetic strength is represented by equation (5) as follows:

$$B = \sqrt{\frac{2 F . d}{μ . m}} \qquad ( 5 )$$

The computer system 202 is further configured to adjust the magnetic field of each robot of the first set of robots 214 based on the magnetic particle data and the set of magnetic field parameters. The magnetic field of each robot of the first set of robots 214 is adjusted to generate the first layer of magnetic particles on the first physical arrangement of the first set of robots 214 in the second shape similar to the first shape. Specifically, the magnetic field of each robot of the first set of robots 214 is adjusted to attract the magnetic particles present at a first distance (such as 10 m) from the first set of robots 214. Additionally, the magnetic field of each robot of the first set of robots 214 is adjusted to steer the magnetic particles towards the first physical arrangement of the first set of robots 214. The steering of the magnetic particles towards the first physical arrangement of the first set of robots 214 leads to an increase thickness of the first layer of magnetic particles on the first physical arrangement of the first set of robots 214.

In an embodiment of the disclosure, the computer system 202 is configured to control an amount of current that flows within a first electromagnetic coil associated with the first robot. The electromagnetic coil is configured to generate the first magnetic field based on the amount of current. Additionally, the computer system 202 is configured to adjust the first magnetic field based on the controlling of the amount of current flows within the first electromagnetic coil. In an embodiment of the disclosure, the computer system 202 is configured to control the amount of current based on the first magnetic strength (denoted by B).

At 310, a second control data generation operation is executed. In the second control data generation operation, the computer system 202 is configured to generate the second control data for each robot of the second set of robots 216 based on the first set of object parameters 208A. The second control data includes the count of the second set of robots 216, the type of each robot of the second set of robots 216, the second set of control signals associated with the position of each robot of the second set of robots 216 within the operational environment and the second set of timestamps associated with the position of each robot of the second set of robots 216 within the operational environment.

In an embodiment of the disclosure, the count of the second set of robots 216 is indicative of a total number of the second set of robots 216 used for the generation of the at least one physical boundary around the at least one portion of the first layer of magnetic particles. In an embodiment of the disclosure, a second type of a second robot of the second set of robots 216 is indicative of one or more classifications associated with the second robot of the second set of robots 216. Examples of the set of one or more classifications include, but are not limited to, the articulated robot type, the electromagnetic manipulator type, the collaborative type, and the magnetic field generator type. In an embodiment of the disclosure, the second control data includes a second set of coordinates to indicate the position of each robot of the second set of robots 216 within the operational environment. In an embodiment of the disclosure, a first timestamp of the second set of timestamps corresponds to a specific time instance associated with a first position of the first robot within the operational environment.

At 312, a second robot control operation is executed. In the second robot control operation, the computer system 202 is configured to control the second set of robots 216 based on the second control data. The second set of robots 216 is controlled to generate the second physical arrangement of the second set of robots 216. The second physical arrangement corresponds to at least one physical boundary around the at least one portion of the first layer of magnetic particles. The physical boundary around the at least one portion of the first layer of magnetic particles allows for holding of the magnetic particles on the first physical arrangement of the first set of robots 214. Additionally, the physical boundary around the at least one portion of the first layer of magnetic particles further allows for an accumulation of additional magnetic particles to increase a dimension of at least one of the first set of dimensions. Accordingly, a flowchart is provided with reference to FIG. 5.

Specifically, the computer system 202 is configured to control the second set of robots 216 to change the location of each robot of the second set of robots 216 within the operational environment. The location of each robot of the second set of robots 216 is changed to generate the second physical arrangement of the second set of robots 216. Accordingly, a diagram is provided with reference to FIG. 4. In an embodiment of the disclosure, the location of each robot of the second set of robots 216 is changed to generate the second physical arrangement of the second set of robots 216 on a top surface of the first physical arrangement of the first set of robots 214. In various embodiments of the disclosure, the computer system 202 is configured to control the second set of robots 216 to generate the second physical arrangement at a second distance (such as 2 meters) from the first physical arrangement. Specifically, the location of each robot of the second set of robots 216 is changed to generate the second physical arrangement of the second set of robots 216 towards one or more portions associated with an outer side surface of the first physical arrangement of the first set of robots 214.

The second physical arrangement includes first one or more rows of robots that are arranged with respect to the outer side surface of the first physical arrangement. Specifically, each robot of the first one or more rows is coupled with the outer side surface of the first physical arrangement. The second physical arrangement further includes one or more columns of robots that are arranged on the top surface of the one or more rows coupled with the outer side surface of the first physical arrangement. Accordingly, a diagram is provided for the second physical arrangement of the second set of robots 216 with reference to FIG. 4.

In an embodiment of the disclosure, the second control data includes a second set of coordinates to indicate the position of the second robot within the second physical arrangement. In an embodiment of the disclosure, the second set of coordinates is denoted as (r, c), where r is a first coordinate that is indicative of a first position of the second robot with respect to the second one or more rows of robots and c is a second coordinate that is indicative of the first position of the second robot with respect to the first one or more columns of robots.

At 314, a heat supply control operation is executed. In the heat supply control operation, the computer system 202 is configured to control the supply of the first amount of heat within the at least one physical boundary around the at least one portion of the first layer of magnetic particles. The first amount of heat is controlled to generate the second physical object 212 with the shape that is similar to the first shape of the first physical object 210. In an embodiment of the disclosure, the computer system 202 is configured to control the supply of the first amount of heat based on the adjustment of the magnetic field and the first set of object parameters 208A. In an embodiment of the disclosure, the computer system 202 is configured to control the intensity of the laser beam around the at least one portion of the first layer of magnetic particles based on the adjustment of the magnetic field and the first set of object parameters 208A. The intensity of the laser beam is controlled to generate the second physical object 212. In various embodiments of the disclosure, the computer system 202 is configured to control a flow of electricity associated with a heating device (such as an induction heater) within the at least one portion of the first layer of magnetic particles based on the adjustment of the magnetic particles and the first set of object parameters 208A. The flow of electricity is controlled to generate the second physical object 212. Specifically, the heating of magnetic particles with the first amount of heat leads to a melting and a bonding between the magnetic particles in the second shape. Moreover, the bonded magnetic particles in the second shape are cooled down to solidify in the second shape, leading to the generation of the second physical object 212.

At 316, a second physical object storage operation is executed. In the second physical object storage operation, the computer system 202 is configured to generate third control data for each robot of a third set of robots based on the generation of the second physical object 212 and the first set of object parameters 208A. The third control data includes a count of the third set of robots, a type of each robot of the third set of robots, a third set of control signals associated with a position of each robot of the third set of robots within the operational environment, and a third set of timestamps associated with the position of each robot of the third set of robots within the operational environment. In an embodiment of the disclosure, the count of the third set of robots is indicative of a total number of the third set of robots for transferring the second physical object 212. In an embodiment of the disclosure, a type of a third robot of the third set of robots is indicative of one or more classifications associated with the third robot of the second set of robots 216. In an embodiment of the disclosure, the third control data includes a third set of coordinates to indicate the position of each robot of the third set of robots within the operational environment. In an embodiment of the disclosure, a first timestamp of the third set of timestamps corresponds to a specific time instance with respect to a position of the third robot within the operational environment.

The computer system 202 is configured to control the third set of robots based on the third control data. The third set of robots is controlled to transfer the second physical object 212 from a first location associated with the operational environment to a second location associated with a storage environment (such as a storage room, a storage vehicle, and the like). In an embodiment of the disclosure, the transfer of the second physical object 212 to the storage room allows for the prevention of the second physical object 212 from adverse environmental conditions (such as rain, snow, high temperature, and the like). In an embodiment of the disclosure, the transfer of the second physical object 212 to the storage vehicle allows for a delivery of the second physical object 212 via the storage vehicle.

FIG. 4 is a diagram 400 that illustrates an exemplary scenario for controlling robots for manufacturing objects using magnetic particles, in accordance with an embodiment of the disclosure. With reference to FIG. 4, there is shown a database 402 that is configured to store a first set of object parameters 402A associated with a first shape of a first physical object 404, a second physical object 406, a first set of robots 408, a second set of robots 410, a first physical arrangement 412 of the first set of robots 408, a magnetic field 414 of each robot of the first set of robots 408, a first layer of magnetic particles 416, a second physical arrangement 418 of the second set of robots 410, and a laser beam 420. The first set of robots 408 includes a first robot 408A, a second robot 408B, up to an Nth robot 408N. The second set of robots 410 includes a first robot 410A, a second robot 410B, up to an Nth robot 410N. With reference to FIG. 4, there is further shown the computer system 202 of FIG. 2.

As shown in FIG. 4, the computer system 202 is configured to obtain the first set of object parameters 402A associated with at least the first shape of the first physical object 404. In an embodiment of the disclosure, the computer system 202 is configured to obtain the first set of object parameters 402A from the database 402. The computer system 202 is further configured to generate the first control data for each robot of the first set of robots 408 based on the first set of object parameters 402A. The first control data includes a count of the first set of robots 408, a type of each robot of the first set of robots 408, a first set of control signals associated with a position of each robot of the first set of robots 408 within the operational environment and a first set of timestamps associated with the position of each robot of the first set of robots 408 within the operational environment. Details about the first control data are provided, for example, in FIG. 3.

The computer system 202 is further configured to control the first set of robots 408 based on the first control data. The first set of robots 408 is controlled to generate a first physical arrangement 412 of the first set of robots 408 in a second shape similar to the first shape. Specifically, the computer system 202 is further configured to change a first location of each of the first set of robots 408 to generate the first physical arrangement 412 of the first set of robots 408 in a second shape similar to the first shape.

In an embodiment of the disclosure, the second shape of the second physical object 406 may be same as the first shape of the first physical object 404 with same dimensions as that of the first physical object 404. For example, if the first physical object 404 may is a cube with dimensions as 6 m length, 6 m breadth, 6 m height, then the second physical object 406 may also be a cube with dimensions as 6 m length, 6 m breadth, 6 m height. In an embodiment, the second shape of the second physical object 406 may be same as the first shape of the first physical object 404 but with dimensions different from the first physical object 404. It may be noted that the dimensions of the second physical object 406 may vary from the dimensions of the first physical object 404 by a threshold value (say by 5% of the dimensions of the first physical object 404). As an additional example, if the first physical object 404 may is a cube with dimensions as 6 m length, 6 m breadth, 6 m height, then the second physical object 406 may also be a cube with dimensions as 5.7-6.3 m length, 5.7-6.3 m breadth, 5.7-6.3 m height.

In an embodiment of the disclosure, the second physical object 406 may be same as the first physical object 404 with same properties (such as sides, exterior angles, interior angles, diagonals, and the like). As an example, the first shape of the first physical object 404 and the second shape of the second physical object 406 may correspond to a first rhombus and a second rhombus identical to the first rhombus, respectively. Further, the first rhombus is associated with a first set of properties that includes at least a set of four sides associated with the first rhombus, a pair of interior angles associated with the first rhombus, a pair of diagonals associated with the first rhombus, and a height associated with the first rhombus. The pair of interior angles includes a first acute angle (denoted by θ) and a first obtuse angle (denoted by (180 degrees−θ)). Further, each diagonal of the pair of diagonals intersects at right angles. Similarly, the second rhombus is associated with a second set of rhombus dimensions identical to at least one dimension of the first set of rhombus dimensions. In an example, a length of each side of the set of four sides is 3 m, the first acute angle (θ) is 60 degrees, the first obtuse angle (180 degrees−60 degrees) is 120 degrees, a length of a first diagonal of the pair of diagonals is 5 m, a length of a second diagonal is 7 m, and the height associated with the first rhombus is 2 m. Similarly, the second set of rhombus dimensions includes at least a pair of interior angles associated with the second rhombus identical to the pair of interior angles associated with the first rhombus. In an example, the pair of interior angles associated with the second rhombus includes a second acute angle (60 degrees) identical to the first acute angle (60 degrees) and a second obtuse angle (120 degrees) identical to the first obtuse angle (120 degrees).

In an embodiment of the disclosure, the second physical object 406 may be the same as the first physical object 404 with different properties (such as sides, exterior angles, interior angles, diagonals, and the like). As an additional example, a size of the second rhombus is decreased based on a predefined angle threshold. The predefined angle threshold is indicative of a predefined angle associated with a change in the first set of dimensions associated with the first physical object 404. In an example, an inclination of the second rhombus is decreased with respect to an inclination of the first rhombus based on the predefined angle threshold. In an additional example, the inclination of the second rhombus is increased with respect to the inclination of the first rhombus based on the predefined angle threshold. In an example, the first acute angle of the first rhombus is 60 degrees and the predefined angle threshold is 10 degrees. Further, the second acute angle of the second rhombus is 70 degrees based on a sum of the first acute angle (60 degrees) of the first rhombus and the predefined angle threshold (10 degrees). An increase in the second acute angle (70 degrees) with respect to the first acute angle (60 degrees) leads to an increase in the inclination of the second rhombus with respect to the inclination of the first rhombus. In an additional example, the second acute angle of the second rhombus is 50 degrees based on a difference between the first acute angle (60 degrees) of the first rhombus and the predefined angle threshold (10 degrees). A decrease in the second acute angle (50 degrees) with respect to the first acute angle (60 degrees) leads to a decrease in the inclination of the second rhombus with respect to the inclination of the first rhombus.

The computer system 202 is further configured to adjust a magnetic field 414 of each robot of the first set of robots 408 based on the first set of object parameters 402A. The magnetic field 414 is adjusted to generate the first layer of magnetic particles 416 on the first physical arrangement 412 of the first set of robots 408.

The computer system 202 is further configured to control the second set of robots 410 based on the second control data to generate the second physical arrangement 418 of the second set of robots 410. The second physical arrangement 418 corresponds to at least one physical boundary around the at least one portion of the first layer of magnetic particles 416. In an embodiment of the disclosure, the computer system 202 is configured to generate second control data for each robot of the second set of robots 410 based on the first set of object parameters 402A. Further, the computer system 202 is configured to control the second set of robots 410 based on the second control data.

The computer system 202 is further configured to control a supply of a first amount of heat around at least one portion of the first layer of magnetic particles 416 based on the adjustment and the first set of object parameters 402A. The first amount of heat is controlled to generate the second physical object 406 having a shape that is similar to the first shape of the first physical object 404. In an embodiment of the disclosure, the computer system 202 is configured to control an intensity of the laser beam 420 around the at least one portion of the first layer of magnetic particles 416 based on the adjustment of the magnetic field 414 and the first set of object parameters 402A. The intensity of the laser beam 420 is controlled to generate the second physical object 406.

FIG. 5 is a diagram that illustrates a first flowchart 500 of a method for controlling robots for manufacturing objects using magnetic particles, in accordance with an embodiment of the disclosure. FIG. 5 is explained in conjunction with elements from FIG. 1, FIG. 2, FIG. 3, and FIG. 4. The operations of the method depicted by the first flowchart 500 may be executed by any computing system, for example, by the computer 102 of FIG. 1 or the computer system 202 of FIG. 2. The operations of the first flowchart 500 may start at 502.

At 502, the first set of object parameters 208A associated with at least the first shape of the first physical object 210 is obtained. In an embodiment of the disclosure, the computer system 202 is configured to obtain the first set of object parameters 208A associated with at least the first shape of the first physical object 210. In an embodiment of the disclosure, the first set of object parameters 208A is associated with the first set of dimensions of the first physical object 210 or the first density of the first physical object 210. The first set of dimensions includes the length of the first physical object 210, the breadth of the first physical object 210, and the height of the first physical object 210. Details about the acquisition of the first set of object parameters 208A are provided, for example, in FIG. 3.

At 504, a second set of object parameters is determined based on the generation of the second physical object 212. The second set of object parameters is associated with at least a second set of dimensions of the second physical object 212. The second set of dimensions includes a length of the second physical object 212, a breadth of the second physical object 212, and a height of the second physical object 212. In an embodiment of the disclosure, the computer system 202 is configured to determine the second set of object parameters based on the generation of the second physical object 212. In an embodiment of the disclosure, the computer system 202 is configured to determine the first set of object parameters 208A from the first one or more sensors associated with the first set of robots 214 and the second one or more sensors associated with the second set of robots 216. For example, the length of the second physical object 212, the breadth of the second physical object 212, and the height of the second physical object 212 are 6 m, 5 m, and 3 m, respectively.

At 506, a difference value between a dimension value associated with a dimension of the first set of dimensions and a dimension value associated with a dimension of the second set of dimensions is determined. In an embodiment of the disclosure, the computer system 202 is configured to determine the difference value between the dimension value associated with the dimension of the first set of dimensions and the dimension value associated with the dimension of the second set of dimensions.

At 508, a determination is made whether the difference value is less than a dimension threshold value or not. In an embodiment of disclosure, the computer system 202 is configured to compare the difference value with the dimension threshold value. In an embodiment of disclosure, the operations of the method proceed to 510 based on a determination that the difference value is not less than the dimension threshold value. Otherwise, the operations of the method proceed to 512 based on a determination that the difference value is less than the dimension threshold value.

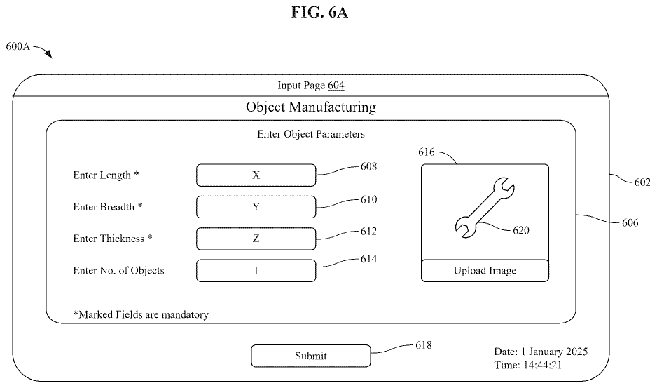

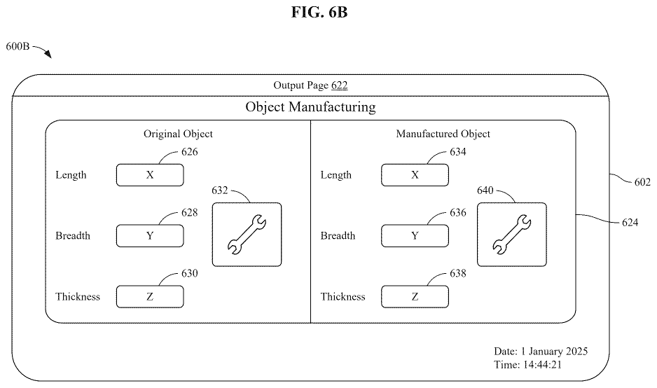

At 510, the first set of dimensions and the second set of dimensions are output on a user interface. In an embodiment of disclosure, the computer system 202 is configured to output the first set of dimensions and the second set of dimensions on the user interface. In an embodiment of the disclosure, the user interface is associated with the computer system 202. Accordingly, diagrams are provided with reference to FIGS. 6A and 6B.

At 512, the second supply of magnetic particles on the first physical arrangement of the first set of robots 214 is controlled based on the comparison. In an embodiment of the disclosure, the computer system 202 is configured to control the second supply of magnetic particles on the first physical arrangement of the first set of robots 214 based on the comparison.

At 514, the magnetic field of each robot of the first set of robots 214 is adjusted based on the second supply of magnetic particles on the first physical arrangement of the first set of robots 214 and the first set of object parameters 208A. The magnetic field is adjusted to generate the second layer of magnetic particles on the first physical arrangement of the first set of robots 214. In an embodiment of the disclosure, the computer system 202 is configured to adjust the magnetic field of each robot of the first set of robots 214 based on the second supply of magnetic particles on the first physical arrangement of the first set of robots 214 and the first set of object parameters 208A.

At 516, the supply of a second amount of heat around at least one portion of the second layer of magnetic particles is controlled based on the adjustment of the magnetic field of each robot of the first set of robots 214. The second amount of heat is controlled to increase the dimensions of the second set of dimensions of the second physical object 212. In an embodiment of the disclosure, the computer system 202 is configured to control the supply of the second amount of heat around at least one portion of the second layer of magnetic particles based on the adjustment of the magnetic field of each robot of the first set of robots 214.

FIG. 6A is a diagram that illustrates an exemplary first user interface for controlling robots for manufacturing objects using magnetic particles, in accordance with an embodiment of the disclosure. FIG. 6A is explained in conjunction with elements from FIG. 1, FIG. 2, FIG. 3, FIG. 4, and FIG. 5. With reference to FIG. 6A, there is shown an exemplary diagram 600A that includes a user device 602 and an exemplary input page 604. The exemplary input page 604 includes a first user interface (UI) element 606, a second UI element 608, a third UI element 610, a fourth UI element 612, a fifth UI element 614, a sixth UI element 616, and a seventh UI element 618. The user device 602 is an example embodiment of the first user device 204 of FIG. 2.

With reference to FIG. 6A, the computer system 202 is configured to receive one or more inputs from the user device 602. The user device 602 includes a display unit that renders the exemplary input page 604 on the user device 602 to be seen by the user 218. In an embodiment, the exemplary input page 604 corresponds to a web page or an online form that is designed to collect information from the user 218 who wishes to generate the second physical object 212. In an embodiment of the disclosure, the exemplary input page 604 is used to gather relevant data from the user to generate the second physical object 212.

The first UI element 606 corresponds to a textbox that includes a message for the user, for example, “Enter Object Parameters”. The first UI element 606 further includes the second UI element 608, the third UI element 610, the fourth UI element 612, the fifth UI element 614, and the sixth UI element 616. The second UI element 608 corresponds to a textbox labeled “Enter Length”. The second UI element 508 is configured to receive the length of the second physical object 212. In an embodiment of the disclosure, the second UI element 608 is a mandatory input parameter that needs to be provided for the generation of the second physical object 212.

The third UI element 610 corresponds to a textbox labeled “Enter Breadth”. The third UI element 610 is configured to receive a breadth of the second physical object 212. In an embodiment of the disclosure, the third UI element 610 is a mandatory input parameter that needs to be provided for the generation of the second physical object 212. The fourth UI element 612 corresponds to a textbox labeled “Enter Thickness”. The fourth UI element 612 is configured to receive a width of the second physical object 212. In an embodiment of the disclosure, the fourth UI element 612 is a mandatory input parameter that needs to be provided for the generation of the second physical object 212.

The fifth UI element 614 corresponds to a textbox labeled “Enter No. of Objects”. The fifth UI element 614 is configured to receive a number of the second physical object 212 that is to be generated.

The sixth UI element 616 corresponds to a display area and is labeled as Upload Image”. The sixth UI element 616 is configured to receive a digital representation 620 of the first physical object 210.”. Upon selecting the sixth UI element 616, the computer system 202 is configured to receive the digital representation of the first physical object 210 in the form of a file in any format such as an image file, a computer-aided design (CAD) file, or the like.

The seventh UI element 618 corresponds to a button and is labeled as “Submit”. Upon selecting the seventh UI element 618, the computer system 202 is configured to control the first set of robots 214 and the second set of robots 216 to generate the second physical object 212.

FIG. 6B is a diagram that illustrates an exemplary second user interface for controlling robots for manufacturing objects using magnetic particles, in accordance with an embodiment of the disclosure. FIG. 6B is explained in conjunction with elements from FIG. 1, FIG. 2, FIG. 3, FIG. 4, FIG. 5, and FIG. 6A. With reference to FIG. 6B, there is shown an exemplary diagram 600B that includes the user device 602 and an exemplary output page 622. The exemplary output page 622 includes an eighth UI element 624 that includes a ninth UI element 626, a tenth UI element 628, an eleventh UI element 630, a twelfth UI element 632, a thirteenth UI element 634, a fourteenth UI element 636, a fifteenth UI element 638, and a sixteenth UI element 640. The user device 602 is an example embodiment of the first user device 204 of FIG. 2.

With reference to FIG. 6B, the computer system 202 is configured to output the first set of dimensions of the first physical object 210 and the second set of dimensions of the second physical object 212 on the exemplary second user interface. The user device 602 includes the display unit (a user interface) that renders the exemplary output page 622 to the user 218. The computer system 202 is configured to render the exemplary output page 622 on the user interface (UI) of the user device 602. The exemplary output page 622 corresponds to a web page or online form that is designed to display the first set of dimensions and the second set of dimensions.

The eighth UI element 624 corresponds to a set of textboxes labeled as “Original Object” for the first set of dimensions associated with the first physical object 210 at the left portion of the eighth UI element 624 and “Manufactured Object” for the second set of dimensions associated with the second physical object 212 at the right portion of the eighth UI element 624.

The ninth UI element 626 corresponds to a textbox labeled “Length”. The ninth UI element 626 is configured to render a length of the first physical object 210. The tenth UI element 628 corresponds to a textbox labeled “Breath”. The tenth UI element 628 is configured to render a breadth of the first physical object 210. The eleventh UI element 630 corresponds to a textbox labeled “Thickness”. The eleventh UI element 630 is configured to render a height of the first physical object 210. The twelfth UI element 632 is configured to render the digital representation 620 of the first physical object 210.”

The thirteenth UI element 634 corresponds to a textbox labeled “Length”. The thirteenth UI element 634 is configured to render a length of the second physical object 212. The fourteenth UI element 636 corresponds to a textbox labeled “Breath”. The fourteenth UI element 636 is configured to render a breadth of the second physical object 212. The fifteenth UI element 638 corresponds to a textbox labeled “Thickness”. The fifteenth UI element 638 is configured to render the height of the second physical object 212. The sixteenth UI element 640 is configured to render the digital representation of the second physical object 212.

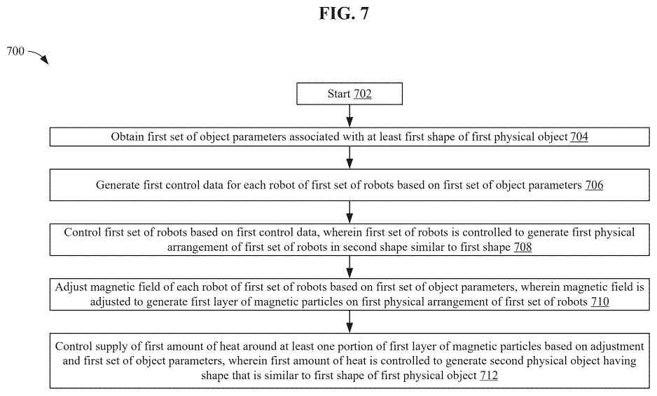

FIG. 7 is a diagram that illustrates a second flowchart 700 of a method for controlling robots for manufacturing objects using magnetic particles, in accordance with an embodiment of the disclosure. FIG. 7 is explained in conjunction with elements from FIG. 1, FIG. 2, FIG. 3, FIG. 4, FIG. 5, FIG. 6A, and FIG. 6B. The operations of the method depicted by the second flowchart 700 may be executed by any computing system, for example, by the computer 102 of FIG. 1 or the computer system 202 of FIG. 2. The operations of the second flowchart 700 may start at 702.

At 704, the first set of object parameters 208A associated with at least the first shape of the first physical object 210 is obtained. In an embodiment of the disclosure, the computer system 202 is configured to obtain the first set of object parameters 208A associated with at least the first shape of the first physical object 210. Details about the acquisition of the first set of object parameters 208A are provided, for example, in FIG. 3.

At 706, the first control data for each robot of the first set of robots 214 is generated based on the first set of object parameters 208A. In an embodiment of the disclosure, the computer system 202 is configured to generate the first control data for each robot of a first set of robots 214 based on the first set of object parameters 208A. Details about the generation of the first control data are provided, for example, in FIG. 3.

At 708, the first set of robots 214 is controlled based on the first control data. The first set of robots 214 is controlled to generate the first physical arrangement of the first set of robots 214 in a second shape similar to the first shape. In an embodiment of the disclosure, the computer system 202 is configured to control the first set of robots 214 based on the first control data. Details about the controlling of the first set of robots 214 are provided, for example, in FIG. 3.

At 710, the magnetic field of each robot of the first set of robots 214 is adjusted based on the first set of object parameters 208A. The magnetic field is adjusted to generate the first layer of magnetic particles on the first physical arrangement of the first set of robots 214. In an embodiment of the disclosure, the computer system 202 is configured to adjust the magnetic field of each robot of the first set of robots 214 based on the first set of object parameters 208A. Details about the adjustment of the magnetic field are provided, for example, in FIG. 3.

At 712, the supply of the first amount of heat around the at least one portion of the first layer of magnetic particles is controlled based on the adjustment and the first set of object parameters 208A. The first amount of heat is controlled to generate the second physical object 212 having a shape that is similar to the first shape of the first physical object 210. In an embodiment of the disclosure, the computer system 202 is configured to control the supply of the first amount of heat around the at least one portion of the first layer of magnetic particles based on the adjustment and the first set of object parameters 208A. Details about the control of the supply of the first amount of heat are provided, for example, in FIG. 3.

While the above steps shown in FIG. 7 are described in a particular sequence, the steps may occur in variations to the sequence in accordance with various embodiments of the present disclosure. Further, details related to various steps of FIG. 7 which are already covered in the description related to FIG. 1, FIG. 2, FIG. 3, FIG. 4, FIG. 5, FIG. 6A and FIG. 6B are not discussed again in detail here for the sake of brevity.

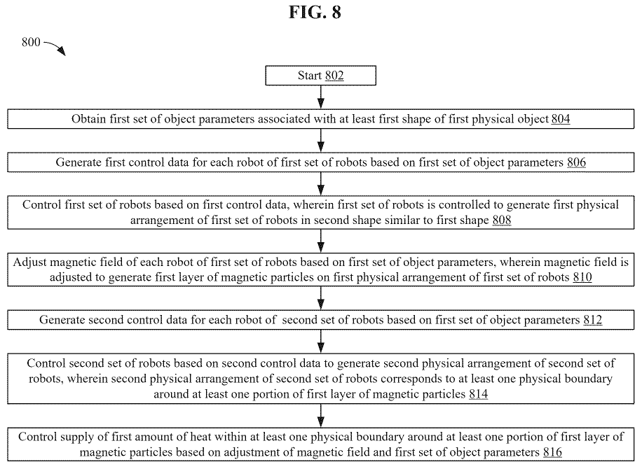

FIG. 8 is a diagram that illustrates a third flowchart 800 of a method for controlling robots for manufacturing objects using magnetic particles, in accordance with an embodiment of the disclosure. FIG. 8 is explained in conjunction with elements from FIG. 1, FIG. 2, FIG. 3, FIG. 4, FIG. 5, FIG. 6A, FIG. 6B, and FIG. 7. The operations of the method depicted by the third flowchart 800 may be executed by any computing system, for example, by the computer 102 of FIG. 1 or the computer system 202 of FIG. 2. The operations of the third flowchart 800 may start at 802.

At 804, the first set of object parameters 208A associated with at least the first shape of the first physical object 210 is obtained. In an embodiment of the disclosure, the computer system 202 is configured to obtain the first set of object parameters 208A associated with at least the first shape of the first physical object 210. Details about the acquisition of the first set of object parameters 208A are provided, for example, in FIG. 3.

At 806, the first control data for each robot of the first set of robots 214 is generated based on the first set of object parameters 208A. In an embodiment of the disclosure, the computer system 202 is configured to generate the first control data for each robot of a first set of robots 214 based on the first set of object parameters 208A. Details about the generation of the first control data are provided, for example, in FIG. 3.

At 808, the first set of robots 214 is controlled based on the first control data. The first set of robots 214 is controlled to generate the first physical arrangement of the first set of robots 214 in the second shape similar to the first shape. In an embodiment of the disclosure, the computer system 202 is configured to control the first set of robots 214 based on the first control data. Detail s about the controlling of the first set of robots 214 are provided, for example, in FIG. 3.

At 810, the magnetic field of each robot of the first set of robots 214 is adjusted based on the first set of object parameters 208A. The magnetic field is adjusted to generate the first layer of magnetic particles on the first physical arrangement of the first set of robots 214. In an embodiment of the disclosure, the computer system 202 is configured to adjust the magnetic field of each robot of the first set of robots 214 based on the first set of object parameters 208A. Details about the adjustment of the magnetic field are provided, for example, in FIG. 3.

At 812, the second control data is generated for each robot of the second set of robots 216 based on the first set of object parameters 208A. In an embodiment of the disclosure, the computer system 202 is configured to generate the second control data for each robot of the second set of robots 216 based on the first set of object parameters 208A. Details about the generation of the second control data are provided, for example, in FIG. 3.

At 814, the second set of robots 216 is controlled based on the second control data to generate the second physical arrangement of the second set of robots 216. The second physical arrangement corresponds to at least one physical boundary around the at least one portion of the first layer of magnetic particles. In an embodiment of the disclosure, the computer system 202 is configured to control the second set of robots 216 based on the second control data to generate the second physical arrangement of the second set of robots 216. Details about the controlling of the second set of robots 216 are provided, for example, in FIG. 3.

At 816, the supply of the first amount of heat is controlled within the at least one physical boundary around the at least one portion of the first layer of magnetic particles based on the adjustment of the magnetic field and the first set of object parameters 208A. In an embodiment of the disclosure, the computer system 202 is configured to control the supply of the first amount of heat within the at least one physical boundary around the at least one portion of the first layer of magnetic particles based on the adjustment of the magnetic field and the first set of object parameters 208A. Details about the controlling the supply of the first amount of heat are provided, for example, in FIG. 3.

While the above steps shown in FIG. 8 are described in a particular sequence, the steps may occur in variations to the sequence in accordance with various embodiments of the present disclosure. Further, details related to various steps of FIG. 8 which are already covered in the description related to FIG. 1, FIG. 2, FIG. 3, FIG. 4, FIG. 5, FIG. 6A, FIG. 6B and FIG. 7 are not discussed again in detail here for the sake of brevity.

The descriptions of the various embodiments of the disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
obtaining, by a computer, a first set of object parameters associated with at least a first shape of a first physical object;
generating, by the computer, first control data for each robot of a first set of robots based on the first set of object parameters;
controlling, by the computer, the first set of robots based on the first control data, wherein the first set of robots is controlled to generate a first physical arrangement of the first set of robots in a second shape similar to the first shape;
adjusting, by the computer, a magnetic field of each robot of the first set of robots based on the first set of object parameters, wherein the magnetic field is adjusted to generate a first layer of magnetic particles on the first physical arrangement of the first set of robots; and
controlling, by the computer, a supply of a first amount of heat around at least one portion of the first layer of magnetic particles based on the adjustment and the first set of object parameters, wherein the first amount of heat is controlled to generate a second physical object having a shape that is similar to the first shape of the first physical object.

2. The computer-implemented method of claim 1, further comprising:
generating, by the computer, second control data for each robot of a second set of robots based on the first set of object parameters;
controlling, by the computer, the second set of robots based on the second control data to generate a second physical arrangement of the second set of robots, wherein the second physical arrangement corresponds to at least one physical boundary around the at least one portion of the first layer of magnetic particles; and
controlling, by the computer, the supply of the first amount of heat within the at least one physical boundary around the at least one portion of the first layer of magnetic particles based on the adjustment of the magnetic field and the first set of object parameters.

3. The computer-implemented method of claim 1, wherein the first control data comprises at least one of a count of the first set of robots, a type of each robot of the first set of robots, a first set of control signals associated with a position of each robot of the first set of robots within an operational environment, or a first set of timestamps associated with the position of each robot of the first set of robots within the operational environment.

4. The computer-implemented method of claim 3, further comprising:
generating, by the computer, third control data for each robot of a third set of robots based on the generation of the second physical object and the first set of object parameters; and
controlling, by the computer, the third set of robots based on the third control data, wherein the third set of robots is controlled to transfer the second physical object from a first location within the operational environment to a second location within a storage environment.

5. The computer-implemented method of claim 1, further comprising:
controlling, by the computer, an intensity of a laser beam around the at least one portion of the first layer of magnetic particles based on the adjustment of the magnetic field and the first set of object parameters, wherein the intensity of the laser beam is controlled to generate the second physical object.

6. The computer-implemented method of claim 1, further comprising:
determining, by the computer, a set of magnetic field parameters based on the first set of object parameters, wherein the set of magnetic field parameters is associated with the magnetic field of each robot of the first set of robots; and
adjusting, by the computer, the magnetic field of each robot of the first set of robots based on the set of magnetic field parameters.

7. The computer-implemented method of claim 6, wherein the set of magnetic field parameters is associated with at least one of a magnetic strength associated with the magnetic field of each robot of the first set of robots or an orientation of the magnetic field of each robot of the first set of robots.

8. The computer-implemented method of claim 6, further comprising:
determining, by the computer, magnetic particle data based on the first set of object parameters, wherein the magnetic particle data comprises at least an amount of magnetic particles in the first layer of magnetic particles; and
adjusting, by the computer, the magnetic field of each robot of the first set of robots based on the magnetic particle data and the set of magnetic field parameters, wherein the magnetic field of each robot of the first set of robots is adjusted to generate the first layer of magnetic particles on the first physical arrangement of the first set of robots.

9. The computer-implemented method of claim 8, further comprising:
controlling, by the computer, a first supply of the magnetic particles on the first physical arrangement of the first set of robots based on the magnetic particle data and the first set of object parameters; and
adjusting, by the computer, the magnetic field of each robot of the first set of robots based on the control of the first supply of the magnetic particles and the first set of object parameters, wherein the magnetic field of each robot of the first set of robots is adjusted to generate the first layer of the magnetic particles on the first physical arrangement of the first set of robots.

10. The computer-implemented method of claim 1, wherein the first set of object parameters is associated with at least one of a first set of dimensions of the first physical object or a first density of the first physical object.

11. The computer-implemented method of claim 10, further comprising:
determining, by the computer, a second set of object parameters based on the generation of the second physical object, wherein the second set of object parameters is associated with at least a second set of dimensions of the second physical object;
determining, by the computer, a difference value between a dimension value associated with a dimension of the first set of dimensions and a dimension value associated with a dimension of the second set of dimensions;
comparing, by the computer, the difference value with a dimension threshold value; and
controlling, by the computer, a second supply of magnetic particles on the first physical arrangement of the first set of robots based on the comparison.

12. The computer-implemented method of claim 11, further comprising:
adjusting, by the computer, the magnetic field of each robot of the first set of robots based on the second supply of the magnetic particles on the first physical arrangement of the first set of robots and the first set of object parameters, wherein the magnetic field is adjusted to generate a second layer of magnetic particles on the first physical arrangement of the first set of robots; and
controlling, by the computer, a supply of a second amount of heat around at least one portion of the second layer of magnetic particles based on the adjustment of the magnetic field of each robot of the first set of robots, wherein the second amount of heat is controlled to increase the dimension of the second set of dimensions of the second physical object.

13. The computer-implemented method of claim 11, further comprising:
outputting, by the computer, the first set of dimensions of the first physical object and the second set of dimensions of the second physical object on a user interface based on the generation of the second physical object.

14. A computer system, comprising:
a processor set;
one or more computer-readable storage media; and
program instructions stored on the one or more computer-readable storage media, the program instructions executable by the processor set to cause the processor set to:
obtain a first set of object parameters associated with at least a first shape of a first physical object;
generate first control data for each robot of a first set of robots based on the first set of object parameters;
control the first set of robots based on the first control data, wherein the first set of robots is controlled to generate a first physical arrangement of the first set of robots in a second shape similar to the first shape;
adjust a magnetic field of each robot of the first set of robots based on the first set of object parameters, wherein the magnetic field is adjusted to generate a first layer of magnetic particles on the first physical arrangement of the first set of robots; and
control a supply of a first amount of heat around at least one portion of the first layer of magnetic particles based on the adjustment and the first set of object parameters, wherein the first amount of heat is controlled to generate a second physical object having a shape that is similar to the first shape of the first physical object.

15. The computer system of claim 14, wherein the program instructions further cause the processor set to:
generate second control data for each robot of a second set of robots based on the first set of object parameters;
control the second set of robots based on the second control data to generate a second physical arrangement of the second set of robots, wherein the second physical arrangement corresponds to at least one physical boundary around the at least one portion of the first layer of magnetic particles; and
control the supply of the first amount of heat within the at least one physical boundary around the at least one portion of the first layer of magnetic particles based on the adjustment of the magnetic field and the first set of object parameters.

16. The computer system of claim 14, wherein the first control data comprises at least one of a count of the first set of robots, a type of each robot of the first set of robots, a first set of control signals associated with a position of each robot of the first set of robots within an operational environment, or a first set of timestamps associated with the position of each robot of the first set of robots within the operational environment.

17. The computer system of claim 14 wherein the program instructions further cause the processor set to:
determine a set of magnetic field parameters based on the first set of object parameters, wherein the set of magnetic field parameters is associated with the magnetic field of each robot of the first set of robots; and
adjust the magnetic field of each robot of the first set of robots based on the set of magnetic field parameters.

18. The computer system of claim 17, wherein the set of magnetic field parameters is associated with at least one of a magnetic strength associated with the magnetic field of each robot of the first set of robots or an orientation of the magnetic field of each robot of the first set of robots.

19. The computer system of claim 17, wherein the program instructions further cause the processor set to:
determine magnetic particle data based on the first set of object parameters, wherein the magnetic particle data comprises at least an amount of magnetic particles in the first layer of magnetic particles; and
adjust the magnetic field of each robot of the first set of robots based on the magnetic particle data and the set of magnetic field parameters, wherein the magnetic field of each robot of the first set of robots is adjusted to generate the first layer of magnetic particles on the first physical arrangement of the first set of robots.

20. A computer program product for controlling robots for manufacturing objects using magnetic particles, the computer program product comprising:
one or more computer-readable storage media; and
program instructions stored on the one or more computer-readable storage media to perform operations comprising:
obtaining a first set of object parameters associated with at least a first shape of a first physical object;
generating first control data for each robot of a first set of robots based on the first set of object parameters;
controlling the first set of robots based on the first control data, wherein the first set of robots is controlled to generate a first physical arrangement in a second shape similar to the first shape;
adjusting a magnetic field of each robot of the first set of robots based on the first set of object parameters, wherein the magnetic field is adjusted to generate a first layer of magnetic particles on the first physical arrangement of the first set of robots; and
controlling a supply of a first amount of heat around at least one portion of the first layer of magnetic particles based on the adjustment and the first set of object parameters, wherein the first amount of heat is controlled to generate a second physical object having a shape that is similar to the first shape of the first physical object.
